(19) United States
(12) Patent Application Publication
(10) Pub. No.: US 2026/0343276 A1
(43) Pub. Date: Oct. 29, 2026

(54) INTEGRITY VALIDATION FOR DOWNLINK CONTROL INFORMATION TRANSMISSIONS

(71) Applicant: QUALCOMM Incorporated, San Diego, CA (US)

(72) Inventors: Marwen ZORGUI, San Diego, CA (US); Mostafa KHOSHNEVISAN, San Diego, CA (US); Tao LUO, San Diego, CA (US)

(21) Appl. No.: 19/571,246

(22) Filed: Mar. 18, 2026

Related U.S. Application Data
(60) Provisional application No. 63/793,455, filed on Apr. 23, 2025.

(51) Int. Cl. H04W 24/08; H04W 72/23

(52) U.S. Cl. CPC H04W 24/08; H04W 72/23

(57) ABSTRACT

Various aspects of the present disclosure generally relate to wireless communication. In some aspects, a user equipment (UE) may receive, from a network node, one or more control information transmissions. The UE may communicate, with the network node, a wireless message, where the wireless message may include first validation content derived from a payload of the one or more control information transmissions, and where the first validation content may be used for an integrity validation of the one or more control information transmissions. Numerous other aspects are described.

### CROSS-REFERENCE TO RELATED APPLICATION

This Patent Application claims priority to U.S. Provisional Patent Application No. 63/793,455, filed on Apr. 23, 2025, entitled “INTEGRITY VALIDATION FOR DOWNLINK CONTROL INFORMATION TRANSMISSIONS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with integrity validation for downlink control information transmissions.

### DESCRIPTION OF RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

Some aspects described herein relate to a user equipment (UE) for wireless communication. The UE may include one or more memories and one or more processors coupled to the one or more memories. The one or more processors may be configured to receive, from a network node, one or more downlink control information (DCI) transmissions. The one or more processors may be configured to communicate, with the network node, a wireless message, wherein the wireless message comprises first validation content derived from a payload of the one or more DCI transmissions, and wherein the first validation content is used for an integrity validation of the one or more DCI transmissions.

Some aspects described herein relate to a UE for wireless communication. The UE may include one or more memories and one or more processors coupled to the one or more memories. The one or more processors may be configured to communicate, with a network node, one or more wireless messages that are encrypted using a first encryption key. The one or more processors may be configured to perform an encryption seed change procedure that generates a second encryption key based at least in part on identifying a security issue associated with the one or more wireless messages. The one or more processors may be configured to transmit, to the network node, a report that indicates an update from using the first encryption key to using the second encryption key.

Some aspects described herein relate to a network node for wireless communication. The network node may include one or more memories and one or more processors coupled to the one or more memories. The one or more processors may be configured to transmit, to a UE, one or more DCI transmissions. The one or more processors may be configured to communicate, with the UE, a wireless message, wherein the wireless message comprises first validation content derived from a payload of the one or more DCI transmissions, and wherein the first validation content is used for an integrity validation of the one or more DCI transmissions.

Some aspects described herein relate to a network node for wireless communication. The network node may include one or more memories and one or more processors coupled to the one or more memories. The one or more processors may be configured to communicate, with a UE, one or more wireless messages that are encrypted using a first encryption key. The one or more processors may be configured to receive, from the UE, a report that indicates an update from using the first encryption key to using a second encryption key. The one or more processors may be configured to perform an encryption seed change procedure that generates the second encryption key based at least in part on receiving the report.

Some aspects described herein relate to a method of wireless communication performed by a UE. The method may include receiving, from a network node, one or more DCI transmissions. The method may include communicating, with the network node, a wireless message, wherein the wireless message comprises first validation content derived from a payload of the one or more DCI transmissions, and wherein the first validation content is used for an integrity validation of the one or more DCI transmissions.

Some aspects described herein relate to a method of wireless communication performed by a UE. The method may include communicating, with a network node, one or more wireless messages that are encrypted using a first encryption key. The method may include performing an encryption seed change procedure that generates a second encryption key based at least in part on identifying a security issue associated with the one or more wireless messages. The method may include transmitting, to the network node, a report that indicates an update from using the first encryption key to using the second encryption key.

Some aspects described herein relate to a method of wireless communication performed by a network node. The method may include transmitting, to a UE, one or more DCI transmissions. The method may include communicating, with the UE, a wireless message, wherein the wireless message comprises first validation content derived from a payload of the one or more DCI transmissions, and wherein the first validation content is used for an integrity validation of the one or more DCI transmissions.

Some aspects described herein relate to a method of wireless communication performed by a network node. The method may include communicating, with a UE, one or more wireless messages that are encrypted using a first encryption key. The method may include receiving, from the UE, a report that indicates an update from using the first encryption key to using a second encryption key. The method may include performing an encryption seed change procedure that generates the second encryption key based at least in part on receiving the report.

Some aspects described herein relate to a non-transitory computer-readable medium that stores a set of instructions for wireless communication by a UE. The set of instructions, when executed by one or more processors of the UE, may cause the UE to receive, from a network node, one or more DCI transmissions. The set of instructions, when executed by one or more processors of the UE, may cause the UE to communicate, with the network node, a wireless message, wherein the wireless message comprises first validation content derived from a payload of the one or more DCI transmissions, and wherein the first validation content is used for an integrity validation of the one or more DCI transmissions.

Some aspects described herein relate to a non-transitory computer-readable medium that stores a set of instructions for wireless communication by a UE. The set of instructions, when executed by one or more processors of the UE, may cause the UE to communicate, with a network node, one or more wireless messages that are encrypted using a first encryption key. The set of instructions, when executed by one or more processors of the UE, may cause the UE to perform an encryption seed change procedure that generates a second encryption key based at least in part on identifying a security issue associated with the one or more wireless messages. The set of instructions, when executed by one or more processors of the UE, may cause the UE to transmit, to the network node, a report that indicates an update from using the first encryption key to using the second encryption key.

Some aspects described herein relate to a non-transitory computer-readable medium that stores a set of instructions for wireless communication by a network node. The set of instructions, when executed by one or more processors of the network node, may cause the network node to transmit, to a UE, one or more DCI transmissions. The set of instructions, when executed by one or more processors of the network node, may cause the network node to communicate, with the UE, a wireless message, wherein the wireless message comprises first validation content derived from a payload of the one or more DCI transmissions, and wherein the first validation content is used for an integrity validation of the one or more DCI transmissions.

Some aspects described herein relate to a non-transitory computer-readable medium that stores a set of instructions for wireless communication by a network node. The set of instructions, when executed by one or more processors of the network node, may cause the network node to communicate, with a UE, one or more wireless messages that are encrypted using a first encryption key. The set of instructions, when executed by one or more processors of the network node, may cause the network node to receive, from the UE, a report that indicates an update from using the first encryption key to using a second encryption key. The set of instructions, when executed by one or more processors of the network node, may cause the network node to perform an encryption seed change procedure that generates the second encryption key based at least in part on receiving the report.

Some aspects described herein relate to an apparatus for wireless communication. The apparatus may include means for receiving, from a network node, one or more DCI transmissions. The apparatus may include means for communicating, with the network node, a wireless message, wherein the wireless message comprises first validation content derived from a payload of the one or more DCI transmissions, and wherein the first validation content is used for an integrity validation of the one or more DCI transmissions.

Some aspects described herein relate to an apparatus for wireless communication. The apparatus may include means for communicating, with a network node, one or more wireless messages that are encrypted using a first encryption key. The apparatus may include means for performing an encryption seed change procedure that generates a second encryption key based at least in part on identifying a security issue associated with the one or more wireless messages. The apparatus may include means for transmitting, to the network node, a report that indicates an update from using the first encryption key to using the second encryption key.

Some aspects described herein relate to an apparatus for wireless communication. The apparatus may include means for transmitting, to a UE, one or more DCI transmissions. The apparatus may include means for communicating, with the UE, a wireless message, wherein the wireless message comprises first validation content derived from a payload of the one or more DCI transmissions, and wherein the first validation content is used for an integrity validation of the one or more DCI transmissions.

Some aspects described herein relate to an apparatus for wireless communication. The apparatus may include means for communicating, with a UE, one or more wireless messages that are encrypted using a first encryption key. The apparatus may include means for receiving, from the UE, a report that indicates an update from using the first encryption key to using a second encryption key. The apparatus may include means for performing an encryption seed change procedure that generates the second encryption key based at least in part on receiving the report.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram of an example of wireless communications system with an aggressor network node.

FIG. 3 is a diagram of an example in accordance with downlink messages carrying content for validating downlink control information (DCI) transmissions.

FIG. 4 is a diagram of an example 400 in accordance with identifying DCI transmissions to use for deriving validation content that is included in a downlink message.

FIG. 5 is a diagram of an example 500 in accordance with uplink messages carrying content for validating DCI transmissions.

FIG. 6 is a diagram of an example 600 in accordance with identifying DCI transmissions to use for deriving validation content that is included in an uplink message.

FIG. 7 is a diagram illustrating an example 700 associated with signaling that enables content validation of DCI transmissions.

FIG. 8 is a diagram illustrating an example 800 associated with signaling that enables a security reestablishment procedure.

FIG. 9 is a diagram illustrating an example process 900 performed, for example, at a user equipment (UE) or an apparatus of a UE.

FIG. 10 is a diagram illustrating an example process 1000 performed, for example, at a UE or an apparatus of a UE.

FIG. 11 is a diagram illustrating an example process 1100 performed, for example, at a network node or an apparatus of a network node.

FIG. 12 is a diagram illustrating an example process 1200 performed, for example, at a network node or an apparatus of a network node.

FIG. 13 is a diagram of an example apparatus 1300 for wireless communication.

FIG. 14 is a diagram of an example apparatus 1400 for wireless communication.

### DETAILED DESCRIPTION

In 3rd Generation Partnership Project (3GPP) radio access technologies (RATs) (such as global system for mobile communications (GSM), universal mobile telecommunications system (UMTS), long-term evolution (LTE), and New Radio (NR)) security functionalities are supported which include ciphering and integrity protection. These security measures may be applied to both the control plane (e.g., radio resource control (RRC) signaling through signaling radio bearers (SRBs)) and the user plane (e.g., user data through data radio bearers (DRBs)) for data in the packet data convergence protocol (PDCP) layer. In some cases, however, one or more layers of a wireless network may not include such security functionalities. For example, Layer 1 (L1) (which is used for downlink control information (DCI) signaling) of a wireless network may not be secured. Non-secure DCI transmissions may present a vulnerability in a wireless communications system where an attacker, such as a rogue network node (e.g., aggressor network node), is capable of sending deceptive DCIs that can mislead a user equipment (UE) or negatively impact system performance. Because DCI transmissions may not be secured, UEs are unable to differentiate between authentic and fabricated DCI transmissions. This inability to identify deceptive or fake DCIs could result in risk to security within a network, as malicious entities could exploit the non-secure architecture of DCI transmissions to send false commands or configurations to UEs, potentially leading to interference and degradation of network performance.

However, securing DCI transmissions by implementing security functionalities for a channel that carries DCIs (e.g., a physical downlink control channel (PDCCH)) and providing a reliable mechanism for UEs to ascertain the authenticity of DCI messages may burden the network with excessive overhead and complexity. This problem may be further compounded if security functionalities are implemented to accommodate various DCI formats or sizes, to account for potential missed DCIs, or to differentiate between missed DCIs and attack scenarios involving fake DCIs. Additionally, such security functionalities used for the control plane and the user plane may not be configured to accommodate for changes in transmission timing, such as when hybrid automatic repeat request (HARQ) retransmissions occur, without losing the integrity of the security checks in place.

Various aspects relate generally to enhancing security mechanisms for detecting potential security issues in wireless communication systems, particularly focusing on validating the integrity of DCI transmissions. Some aspects more specifically relate to a UE receiving one or more DCI transmissions from a network node and communicating with the network node by sending or receiving a wireless message that includes validation content derived from the payload of the DCI transmissions. This validation content may be used in performing an integrity validation of the DCI transmissions, thereby enabling the UE to verify the authenticity of the control information that the UE receives.

In some aspects, the wireless message can be a downlink transport block containing first validation content, and the UE can generate corresponding second validation content based on the received DCI transmissions. The integrity of the DCIs may be validated by comparing the first and second validation contents. If a mismatch is detected, the UE may transmit a report to the network node, indicating an integrity validation failure, which could signal a potential security issue. In other aspects, the wireless message may be an uplink transport block transmitted by the UE to the network node, with the UE including the first validation content in the uplink transport block for the network node to perform the integrity validation. This may prompt the network to undertake a security reestablishment procedure if necessary, based on the outcome of the integrity validation. Additionally, the described techniques can be applied to a variety of DCI formats and sizes, with the techniques being adaptable to separate integrity validation procedures for different DCI configurations or a single procedure for multiple configurations. The techniques may also take into account the timing of DCI transmissions by considering a time window relative to the transmission time of the wireless message.

Particular aspects of the subject matter described in this disclosure can be implemented to realize one or more potential technical benefits. For example, the described aspects can improve an ability of a network to mitigate potential security breaches efficiently by reducing false alarm rates and enhancing the precision of security threat detection. Additionally, the described techniques may leverage security functionalities already established in the control and user planes by including the validation content of DCI transmissions in secured PDSCH and PUSCH messages. Additionally, the flexibility in accommodating various DCI formats and sizes ensures that the DCI content validation is scalable and can be integrated into different communication system configurations. Additionally, by permitting the UE to autonomously initiate a seed change resulting in an update of the security or encryption key, the techniques described herein provide a robust defense against security threats while conserving network resources. This autonomous action, along with reporting capabilities, contributes to a synchronized security response between the UE and the network node, enhancing the overall security framework of the wireless communication system. In this way, the techniques described herein may conserve processing resources, memory resources, network resources, of the like by enabling efficient integrity validation procedures and minimizing network traffic due to false security alarms.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

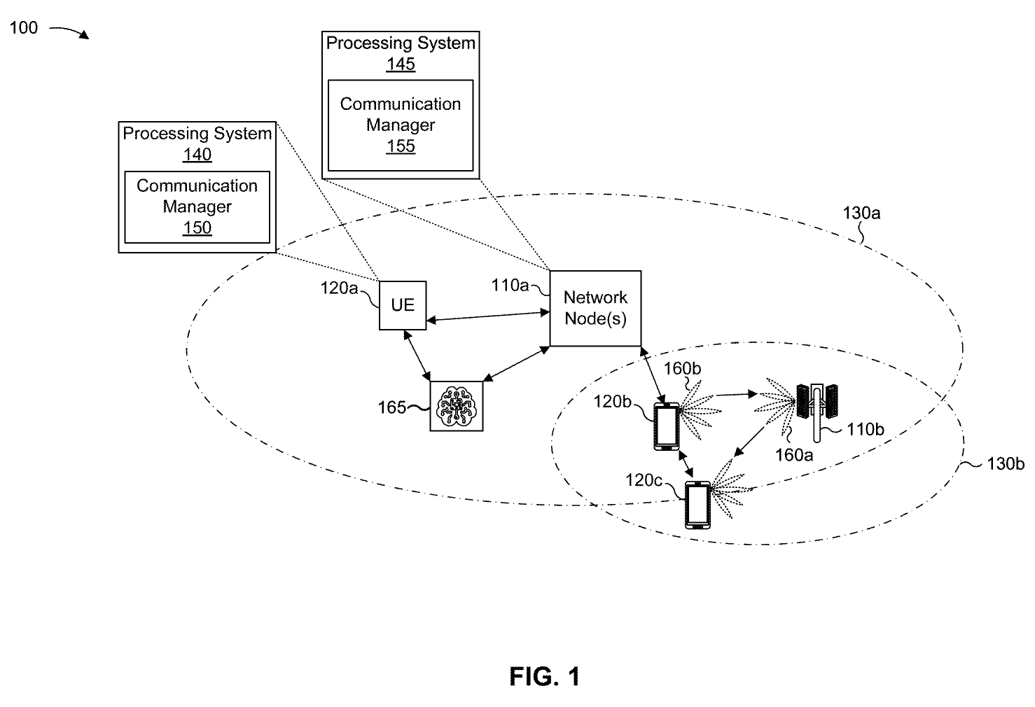

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, HARQ information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may receive, from a network node, one or more DCI transmissions; and communicate, with the network node, a wireless message, wherein the wireless message comprises first validation content derived from a payload of the one or more DCI transmissions, and wherein the first validation content is used for an integrity validation of the one or more DCI transmissions.

In some aspects, the communication manager 150 may communicate, with a network node, one or more wireless messages that are encrypted using a first encryption key; perform an encryption seed change procedure that generates a second encryption key based at least in part on identifying a security issue associated with the one or more wireless messages; and transmit, to the network node, a report that indicates an update from using the first encryption key to using the second encryption key. Additionally, or alternatively, the communication manager 150 may perform one or more other operations described herein.

In some aspects, the network node 110 may include a communication manager 155. As described in more detail elsewhere herein, the communication manager 155 may transmit, to a UE, one or more DCI transmissions; and communicate, with the UE, a wireless message, wherein the wireless message comprises first validation content derived from a payload of the one or more DCI transmissions, and wherein the first validation content is used for an integrity validation of the one or more DCI transmissions.

In some aspects, the communication manager 155 may communicate, with a UE, one or more wireless messages that are encrypted using a first encryption key; receive, from the UE, a report that indicates an update from using the first encryption key to using a second encryption key; and perform an encryption seed change procedure that generates the second encryption key based at least in part on receiving the report. Additionally, or alternatively, the communication manager 155 may perform one or more other operations described herein.

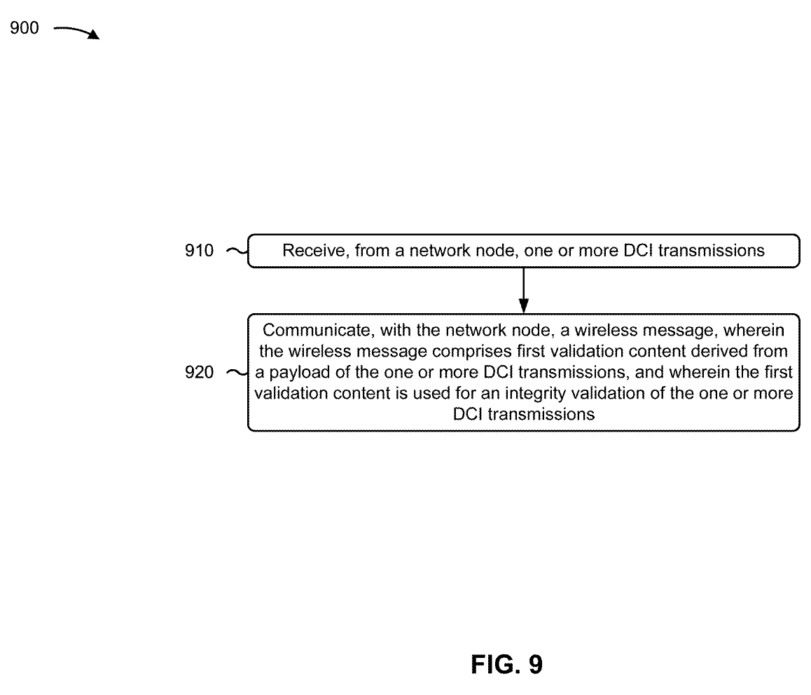

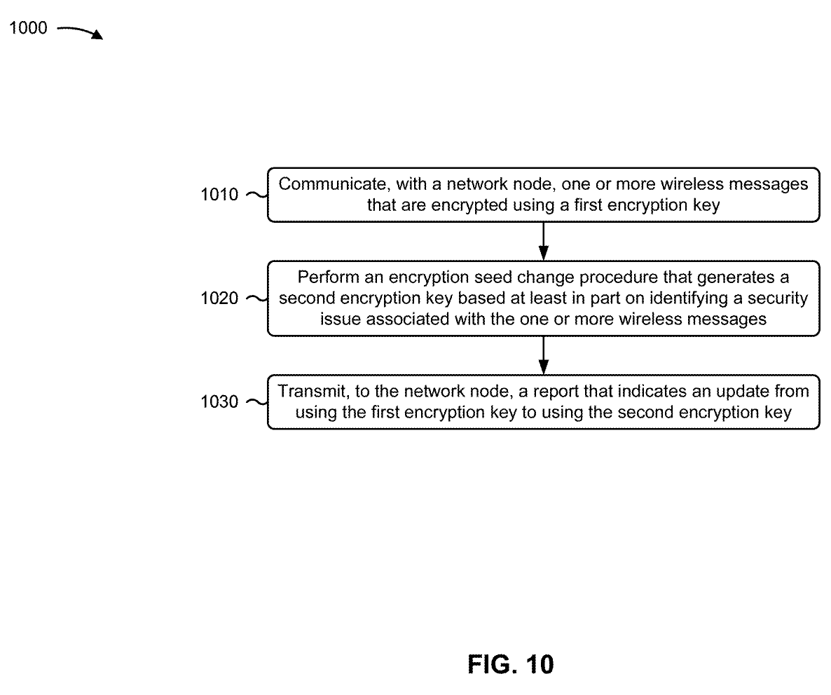

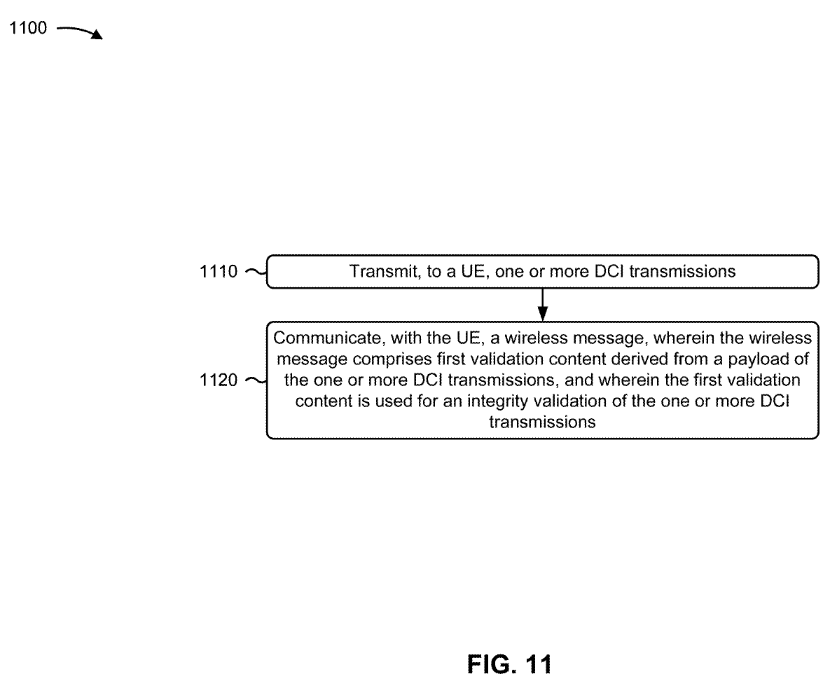

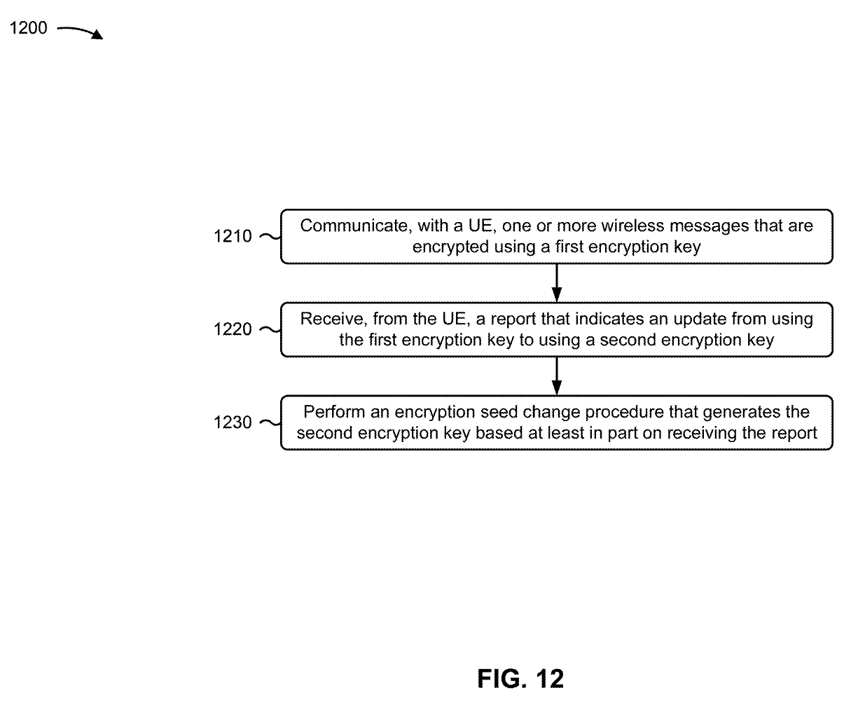

The network node 110, the processing system 145 of the network node 110, the UE 120, the processing system 140 of the UE 120, or any other component(s) of FIG. 1 may implement one or more techniques or perform one or more operations associated with integrity validation for downlink control information transmissions, as described in more detail elsewhere herein. For example, the processing system 145 of the network node 110, or the processing system 140 of the UE 120 may perform or direct operations of, for example, process 900 of FIG. 9, process 1000 of FIG. 10, process 1100 of FIG. 11, process 1200 of FIG. 12, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 900 of FIG. 9, process 1000 of FIG. 10, process 1100 of FIG. 11, process 1200 of FIG. 12, or other processes as described herein. In some examples, executing instructions may include running the instructions, converting the instructions, compiling the instructions, or interpreting the instructions, among other examples.

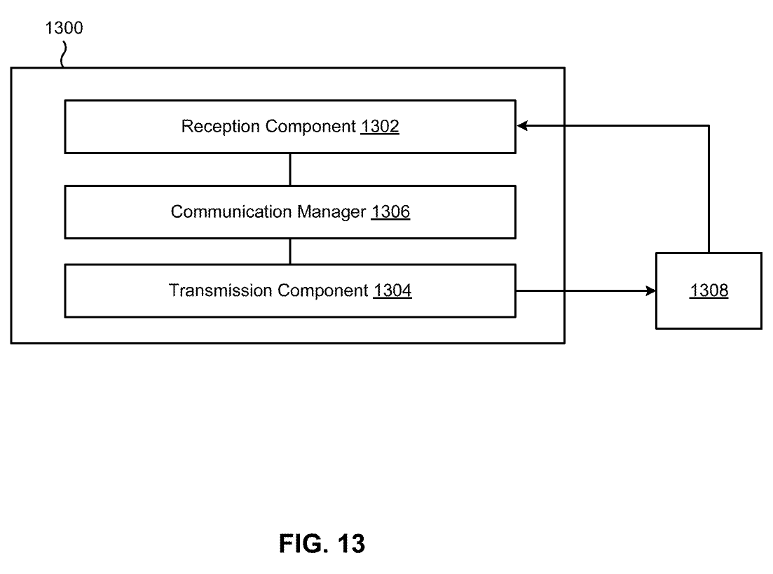

In some aspects, the UE 120 includes means for receiving, from a network node, one or more DCI transmissions; or means for communicating, with the network node, a wireless message, wherein the wireless message comprises first validation content derived from a payload of the one or more DCI transmissions, and wherein the first validation content is used for an integrity validation of the one or more DCI transmissions. In some aspects, the UE 120 includes means for communicating, with a network node, one or more wireless messages that are encrypted using a first encryption key; means for performing an encryption seed change procedure that generates a second encryption key based at least in part on identifying a security issue associated with the one or more wireless messages; or means for transmitting, to the network node, a report that indicates an update from using the first encryption key to using the second encryption key. The means for UE 120 to perform operations described herein may include, for example, one or more of communication manager 150, processing system 140, a radio, one or more RF chains, one or more transceivers, one or more antennas, one or more modems, a reception component (for example, reception component 1302 depicted and described in connection with FIG. 13), or a transmission component (for example, transmission component 1304 depicted and described in connection with FIG. 13), among other examples.

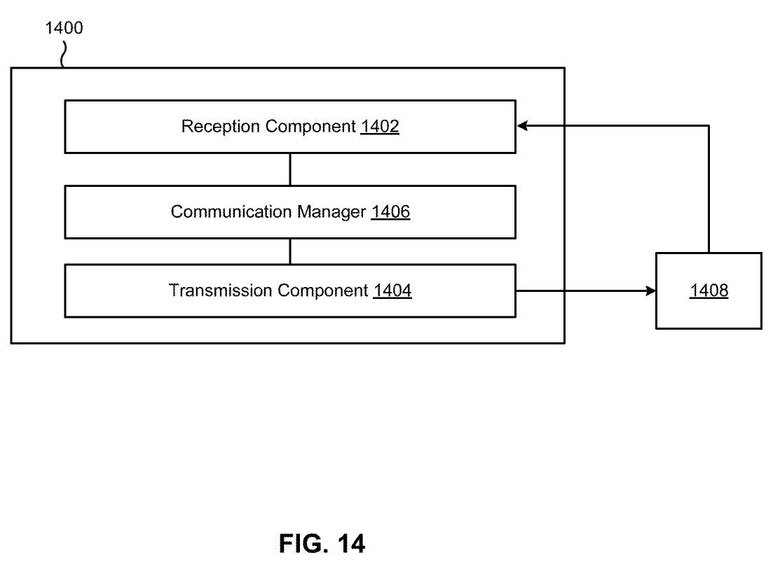

In some aspects, the network node 110 includes means for transmitting, to a UE, one or more DCI transmissions; or means for communicating, with the UE, a wireless message, wherein the wireless message comprises first validation content derived from a payload of the one or more DCI transmissions, and wherein the first validation content is used for an integrity validation of the one or more DCI transmissions. In some aspects, the network node includes means for communicating, with a UE, one or more wireless messages that are encrypted using a first encryption key; means for receiving, from the UE, a report that indicates an update from using the first encryption key to using a second encryption key; or means for performing an encryption seed change procedure that generates the second encryption key based at least in part on receiving the report. The means for the network node to perform operations described herein may include, for example, one or more of communication manager 155, processing system 145, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

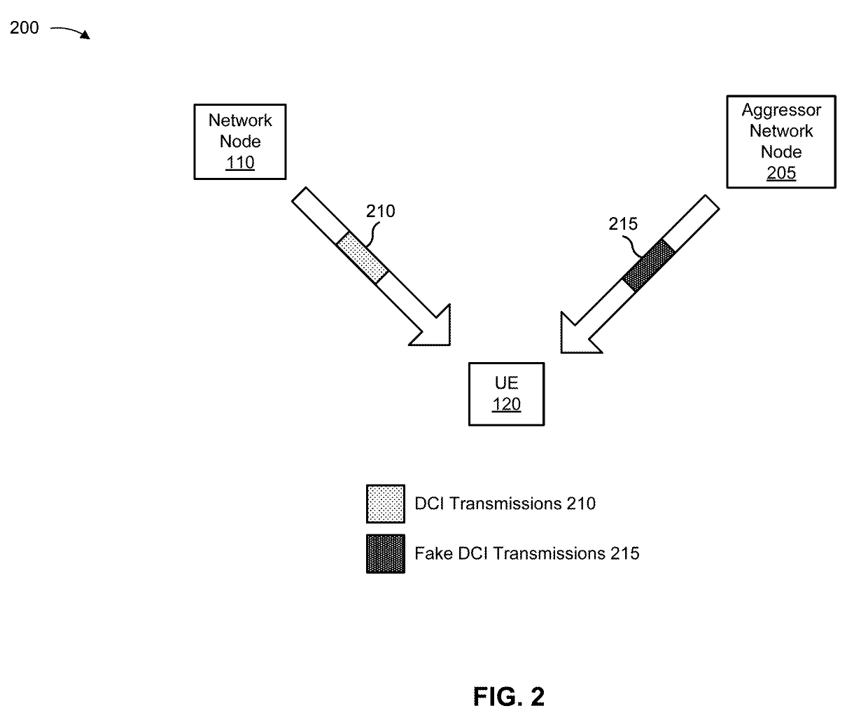

FIG. 2 is a diagram of an example 200 of a wireless communications system with an aggressor network node. In some examples, FIG. 2 may implement one or more aspects of FIG. 1. For example, as shown, FIG. 2 includes the UE 120 and the network node 110 described elsewhere herein. Additionally, FIG. 2 includes an aggressor network node 205, which may be an example of a second network node 110.

In some instances, the example 200 may operate in accordance with one or more RATs (e.g., 3GPP RATs) that support security functionalities. For instance, 3GPP RATs such as GSM, UMTS, LTE, and NR include one or more security functionalities that ensure the confidentiality, integrity, and authenticity of communications within the network. These RATs support a range of security functionalities, including ciphering and integrity protection, which are applied to both the control plane and user plane data. For instance, ciphering may be used to encrypt data, making the data unintelligible to unauthorized parties, while integrity protection may ensure that the data has not been tampered with during transmission. In the control plane, security measures are applied to RRC signaling through signaling radio bearers (SRBs). The SRBs may ensure that the commands and control messages exchanged between the UE 120 and the network node 110 are secure and reliable. For user plane data, which includes the actual user data being transmitted, security may be applied through data radio bearers (DRBs) in the packet data convergence protocol (PDCP) layer. This dual-layer approach ensures comprehensive protection for both signaling and user data. Additionally, or alternatively, the network node 110 and the UE 120 may operate in accordance with an access security management entity (ASME) key. The ASME key may be derived during an authentication process and is used to generate further keys for ciphering and integrity protection. This hierarchical key management system ensures that even if one key is compromised, the overall security of the communication remains intact. By implementing these robust security measures, 3GPP RATs provide a secure environment for mobile communications, protecting user data and maintaining the integrity of the network.

As shown by FIG. 2, the example 200 may include the network node 110, the aggressor network node 205, and the UE 120. For example, the network node 110 and the UE 120 may communicate through one or more DCI transmissions 210. A DCI transmission may be a type of message used in wireless communication systems to convey control information from the network node 110 to the UE 120. DCI transmissions include information such as one or more of scheduling assignments, resource allocations, or power control commands, which are used for managing the communication link between the network node 110 and the UE 120. These transmissions help coordinate the timing and frequency resources that the UE 120 should use for one or more uplink or downlink data transmissions. By receiving and interpreting DCI transmissions, the UE 120 can efficiently communicate with the network node 110, ensuring optimal performance and reliable connectivity within the wireless network.

In some examples, however, the aggressor network node 205 may attempt to interfere with communications between the UE 120 and the network node 110 by sending fake DCI transmissions 215 to the UE 120. In some aspects, the fake DCI transmissions 215 are intended to mislead the UE 120 or impact system performance by mimicking legitimate DCI transmissions (e.g., the DCI transmissions 210). Additionally, the DCI framework may be part of the Layer 1 (L1) signaling architecture which may not include security protection. Therefore, the UE 120 cannot distinguish between the true and fabricated DCI transmissions, leading to potential security issues. For example, the fake DCI transmissions 215 may indicate for the UE 120 to transmit one or more wireless transmissions (such as SRS) to the network node 110, which may increase the signaling overhead and may interfere with one or more transmissions by the network node 110. Accordingly, the wireless transmissions scheduled by the fake DCI transmissions 215 may increase interference in the wireless communications system, which may result in one or more wireless messages being dropped, increasing latency, and reducing quality of service.

Additionally, the DCI transmissions 210 may be carried via a PDCCH. However, transmissions via PDCCH may happen at a much higher occurrence as compared to other channel types (such as PDSCH and PUSCH). Accordingly, implementing security functionalities to secure the PDCCH (such as encryption or ciphering) may increase the complexity and latency associated with transmitting the DCI transmissions 210.

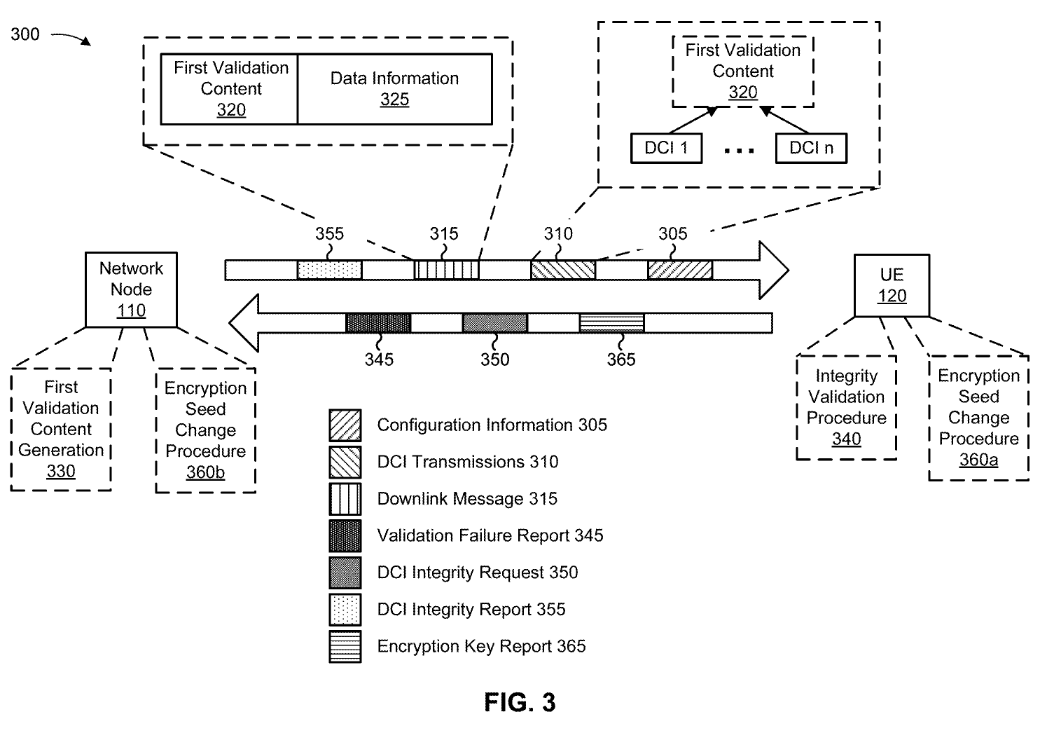

FIG. 3 is a diagram of an example 300 in accordance with downlink messages carrying content for validating DCI transmissions. In some examples, FIG. 3 may implement one or more aspects of FIG. 1. For example, as shown, FIG. 3 includes the UE 120 and the network node 110 described elsewhere herein. Additionally, the DCI transmissions 310 may be examples of the DCI transmissions 210.

As shown in FIG. 3, the network node 110 may transmit, and the UE 120 may receive, configuration information 305. In some examples, the configuration information 305 may be transmitted via one or more of system information (e.g., including master information block (MIB) or SIB), RRC signaling, MAC signaling (e.g., including one or more MAC-CEs), or DCI signaling. The configuration information 305 may include or indicate one or more parameters described herein that enable integrity validation for DCI transmissions. Further description of the configuration information 305 is provided elsewhere herein.

As shown in FIG. 3, the network node 110 may transmit, and the UE 120 may receive, one or more DCI transmissions 310. In example 300, the DCI transmissions 310 include DCI 1 through DCI n, but in other examples, the DCI transmissions 310 may include any number of DCI transmissions.

As shown in FIG. 3, the network node 110 may transmit, and the UE 120 may receive, a downlink message 315 (e.g., a downlink transport block carried via a PDSCH). Additionally, the downlink message 315 may include first validation content 320 and data information 325. As shown in FIG. 3, the first validation content 320 is content derived from the payload of the one or more DCI transmissions 310. For example, the network node 110 may perform a first validation content generation 330 to generate the first validation content. The network node 110 may perform the first validation content generation 330 in accordance with one or more techniques.

In some examples of the first validation content generation 330, the DCI payload (before cyclic redundancy check (CRC) attachment) from the one or more DCI transmissions 310 is considered. In some examples, the first validation content 320 may be the concatenated payload combined from each of the one or more DCI transmissions 310 (e.g., the first validation content 320 includes the set of bits of DCI 1 followed by the set of bits of DCI 2, and so on, and ends with set of bits of DCI n). Concatenating the payloads across the one or more DCI transmissions 310 may reduce complexity in generating the first validation content 320 and enables the first validation content 320 to include information from DCIs of different DCI formats or sizes. In some examples, the network node 110 may perform a bit-wise exclusive or (XOR) computation across the one or more payloads of the one or more DCI transmissions 310 (if the DCIs all have a same payload size). For example, “bit-wise XOR computation” refers to an operation that takes multiple binary numbers of equal length and performs the XOR operation on each corresponding pair of bits. The XOR operation outputs a “1” if the corresponding bits are different (one is “0” and the other is “1”) and outputs a “0” if the corresponding bits are the same (both are “0” or both are “1”). Performing the bit-wise XOR computation across the one or more payloads may reduce the size of the first validation content 320, which may reduce signal overhead (if the DCIs are of the same DCI field size).

In some examples of the first validation content generation 330, a specific field from the one or more DCI transmission 310 may be considered. For example, the network node 110 may use bits from the frequency domain resource allocation (FDRA) field of the DCI transmissions 310, use bits from the time domain resource allocation (TDRA) field of the DCI transmissions 310, or some other field of the DCI transmissions 310. In some examples, the first validation content 320 may be the concatenated bits from the specific field from each of the DCI transmissions 310. In some examples, the first validation content 320 may be a bit-wise XOR computation of the bits from the specific field from each of the DCI transmissions 310. By using the bits from a single field of the DCI transmissions 310 (e.g., rather than the full payload), the size of the first validation content 320 may be reduced, reducing signaling overhead.

In some examples of the first validation content generation 330, the CRCs from the one or more DCI transmissions 310 may be considered. For example, the network node 110 may use the CRC bits from the DCI transmissions 310 to generate the first validation content. In some examples, the first validation content 320 may be the concatenated bits from the CRCs from each of the DCI transmissions 310. In some examples, the first validation content 320 may be a bit-wise XOR computation of the bits from the CRCs from each of the DCI transmissions 310. By using the bits of the CRCs of the DCI transmissions 310 (e.g., rather than the full payload), the size of the first validation content 320 may be reduced, reducing signaling overhead.

In some examples of the first validation content generation 330, a hashing function may be used. A hashing function may be a mathematical algorithm that takes an input and returns a fixed-size string of bits, such as a hash value. The output is unique to each unique input, making the hashing function useful for verifying data integrity, and is difficult for other wireless devices (such as the aggressor network node 205) to reverse engineer. For example, the hashing function may take the payload, a specific field, or the CRC of each of the DCI transmissions 310 as input and derive or output a fixed number of bits to include in the first validation content 320. In some examples, the hashing function may be an authentication function (that may be known to the network node 110 and the UE 120), where the authentication function is based on a security key used by the network node 110 and the UE 120 to encrypt wireless messages. In some examples, the configuration information 305 may indicate the hashing function or the authentication function. In some examples, the configuration information 305 may indicate for the UE 120 to use a currently-in-use security key to generate the hashing function.

After generating the first validation content 320, the network node 110 may include or embed the first validation content 320 into the downlink message 315. In some examples, the first validation content 320 may be at the beginning of the payload for the downlink message 315. In other examples, the first validation content 320 may be at the end of the downlink message 315 or interleaved with the data information 325.

Based on receiving the downlink message 315, the UE 120 may decode and identify the first validation content 320. Accordingly, the UE 120 may perform an integrity validation procedure 340 to identify whether the DCI transmissions 310 are valid. For example, the UE 120 may generate second validation content using the same process and operations performed by the network node 110 during the first validation content generation 330. In some examples, the configuration information 305 may indicate the operations used for the first validation content generation 330, or the operations used may be defined in a wireless communications standard (e.g., 3GPP). If the second validation content matches the first validation content 320, then the UE 120 determines that the DCI transmissions 310 are valid and originated from the network node 110.

If the second validation content matches the first validation content 320, then the UE 120 may determine that an integrity check of the DCI transmissions 310 failed. Accordingly, the UE 120 may transmit, and the network node 110 may receive, a validation failure report 345. In some examples, the validation failure report 345 may be transmitted via one or more of UCI signaling (e.g., L1), MAC-CE signaling (e.g., L2), or MAC-SDU signaling (e.g., higher layer signaling). In some examples, the validation failure report 345 may include a binary indication (e.g., a single bit) that indicates a potential integrity issue. Indicating a single bit in the validation failure report 345 may reduce signaling overhead. Additionally, or alternatively, the validation failure report 345 may include the first validation content 320. Indicating the first validation content 320 may indicate to the network node 110 that the validation failure report 345 corresponds to the DCI transmissions 310, reducing confusion between the UE 120 and network node 110. Additionally, or alternatively, the validation failure report 345 may include more granular information (e.g., the number of DCI transmissions received by the UE 120 and the first validation content 320). Indicating the more granular information may enable the network node 110 to better identify the cause of the validation failure, which may reduce latency in identifying a potential aggressor network node 205 or resolving the validation failure.

In some examples, the integrity validation procedure 340 may fail due to false alarm, such as the UE 120 not successfully receiving one or more of the DCI transmissions 310. Accordingly, the UE 120 and the network node 110 may determine a security issue if there are a certain number of integrity check failures within a duration of time. In other words, the UE 120 and the network node 110 may determine a security issue if the rate of occurrence of validation failures satisfies a rate of occurrence threshold. In some examples, the network node 110 may indicate the rate of occurrence threshold in the configuration information 305.

In some examples, the PDSCH messages that include the first validation content 320 may be selective (e.g., not present in all PDSCHs to reduce signal overhead). Accordingly, the network node 110 may select to include the first validation content 320 in the downlink message 315 based on one or more characteristics of the downlink message 315. For example, including the first validation content 320 may be enabled for one or more component carriers or one or more HARQ identifiers. In some examples, the configuration information 305 may indicate the one or more component carriers or one or more HARQ identifiers that are enabled. In some examples, the network node 110 may indicate that a PDSCH carries validation content dynamically. For instance, the network node 110 may transmit, and the UE 120 may receive, a scheduling DCI that schedules the downlink message 315, where the scheduling DCI indicates that the downlink message 315 includes the first validation content 320. In examples where the downlink message 315 is a semi-persistent scheduling (SPS) PDSCH message, the activating DCI (that activates the SPS-PDSCH message) may indicate that the downlink message 315 includes the first validation content 320, or the configuration information 305 may include an SPS configuration (e.g., SPS-Config in an RRC configuration) that indicates that the downlink message 315 includes the first validation content 320.

If the UE 120 suspects that it is receiving fake DCIs (based on one or more techniques described herein), then the UE 120 may request for the network node 110 to transmit DCI integrity content. For example, the UE 120 may transmit, and the network node 110 may receive, a DCI integrity request 350 (e.g., via RRC signaling, MAC signaling, or UCI signaling). In some examples, the DCI integrity request 350 may indicate a time window corresponding to the DCI integrity request 350. In other words, the DCI integrity request 350 corresponds to any DCIs transmitted from the network node 110 to the UE 120 during the indicated time window. Accordingly, the network node 110 may transmit a DCI integrity request 350, that may include the integrity content corresponding to the requested DCIs. For example, if the DCI integrity request 350 indicates a time window that spans the DCI transmissions 310, then the DCI integrity request 350 may indicate the first validation content 320. Therefore, the DCI integrity request 350 may enable the UE 120 to selectively request validation content for a specific set of DCIs, enabling the UE 120 to determine whether one or more received DCIs originated from the network node 110 or are fake DCIs.

As described herein, one or more of the UE 120 or network node 110 may detect a security issue. For example, the UE 120 and the network node 110 may detect a security issue based on the integrity validation procedure 340 failing, based on the validation failure report 345, based on the rate of occurrence of the validation failure satisfying the rate of occurrence threshold, based on the DCI integrity report 355, or a combination thereof. In some other examples, the UE 120 may determine a security issue that is separate from or independent of the DCI transmissions 310. In other words, a detection mechanism (employed at one or more of the UE 120 or the network node 110) for identifying a security issue is not limited to identifying fake DCI transmissions.

If the UE 120 determines or detects a security issue, then the UE 120 may initiate a seed change that results in updating an encryption key (or security key). For example, an encryption key is a secret value used by both the network node 110 and the UE 120 to encrypt and decrypt messages, ensuring secure communication. The UE 120 may obtain the encryption key through an authentication process configured via the configuration information 305 (e.g., RRC signaling from the network node 110). During this process, the UE 120 and the network node 110 may use an authentication function (configured via the configuration information 305) to generate an encryption key use. Accordingly, the UE 120 and the network node 110 may use a first encryption key prior to the UE 120 detecting the security issue. In accordance with identifying the security issue, the UE 120 initiates a seed change (using an encryption seed change procedure 360a) that updates the encryption key. For example, the UE 120 may use one or more parameters or functions (e.g., the authentication function) for deriving the updated encryption key (e.g., a new seed). Therefore, even if an aggressor network node 205 identifies that the UE 120 is updating the encryption key, updating the encryption key using the authentication function ensures that the aggressor network node 205 is unaware of the updated encryption key.

Additionally, the UE 120 may report updating the encryption key to the network node 110 so that the network node 110 may update the encryption key as well. For example, the UE 120 may transmit an encryption key report 365 (e.g., via RRC signaling, MAC-CE signaling, MAC-SDU signaling, or UCI signaling) that indicates for the network node 110 to update the encryption key. Based on receiving the encryption key report 365, the network node 110 may perform an encryption seed change procedure 360b to derive the second encryption key (e.g., similar to the encryption seed change procedure 360a). In some examples, the timeline for the UE 120 updating from a first encryption key to a second encryption key may be a time (fixed or configurable) after the UE 120 transmits the encryption key report. For instance, the configuration information 305 may indicate or the UE 120 may be pre-configured with a timer, where after expiration of the timer the UE 120 and the network node 110 may start encrypting and decrypting subsequent wireless messages using the second encryption key. Waiting the duration of the timer may enable both the network node 110 and the UE 120 to perform the authentication function to derive the second encryption key such that the network node 110 and the UE 120 may both switch to using the second encryption key at the same time.

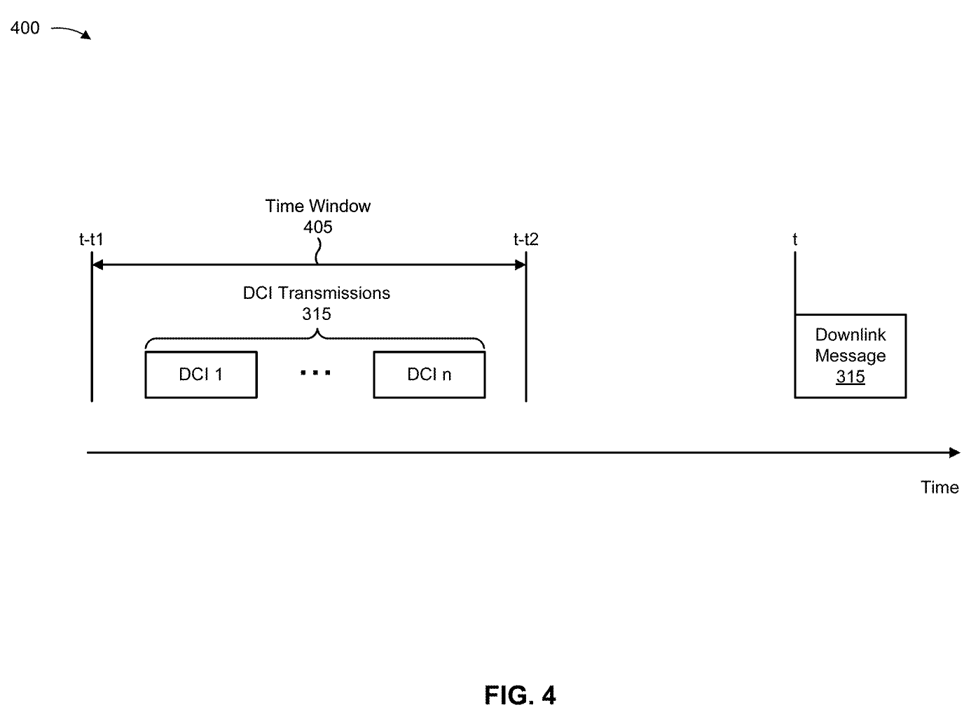

FIG. 4 is a diagram of an example 400 in accordance with identifying DCI transmissions to use for deriving validation content that is included in a downlink message. In some examples, FIG. 4 may implement one or more aspects of FIGS. 1-3. For example, as shown FIG. 4 includes wireless communications between the UE 120 and the network node 110 described elsewhere herein. For instance, FIG. 4 shows a timing diagram of the UE 120 receiving DCI 1 through DCI n (e.g., DCI transmissions 310) and the UE 120 receiving the downlink message 315. As shown in FIG. 4, the one or more DCI transmissions 310 may fall within a time window 405. The configuration of the time window 405 may be described herein.

In some examples, the one or more DCI transmissions 310 may have one or more of the same DCI format or same DCI size. For instance, in one example, the network node 110 and the UE 120 may only consider downlink grants to use for deriving the first validation content (e.g., DCI formats scheduling downlink transport blocks). In other words, non-downlink-grant DCIs that are received by the UE 120 within the time window 405 are not considered part of the one or more DCI transmissions 310. Alternatively, in one example, the network node 110 and the UE 120 may only consider DCIs scheduling initial uplink or downlink transmissions for deriving the first validation content (e.g., not consider DCIs scheduling HARQ retransmissions). Considering DCIs of the same DCI format or same DCI size may enable the network node 110 and the UE 120 to focus on validating specific types of DCIs rather than validating all DCI communications, which may reduce complexity for deriving the first validation content and performing the integrity validation procedure 340. In some examples, the network node 110 and the UE 120 may concurrently perform separate or independent DCI validation procedures for DCIs of different sizes or formats (e.g., a first DCI validation procedure for downlink grant DCIs and a second DCI validation procedure for DCIs scheduling initial uplink or downlink transmissions).

In some examples, the one or more DCI transmissions 310 may have one or more of the same DCI format or the same DCI size. In other words, any DCI received by the UE 120 during the time window 405 may be considered part of the one or more DCI transmissions 310.

In some examples, the DCI that schedules the downlink message 315 (if the downlink message 315 is not an SPS-PDSCH message) may or may not be included as part of the one or more DCI transmissions 310. In some examples, the scheduling DCI is part of the one or more DCI transmissions 310 if the UE 120 receives the scheduling DCI during the time window 405. In some examples, whether the scheduling DCI is part of the one or more DCI transmissions 310 is based on a scheduling offset (K0) between the scheduling DCI and the downlink message 315. For instance, if K0 is greater than zero, then the scheduling DCI is included in the one or more DCI transmissions 310, and if K0 is equal to zero, then the scheduling DCI is not included in the one or more DCI transmissions 310. In some examples, the value of K0 may be indicated via the scheduling DCI.

In some examples, the time window 405 may be based on a set of timing parameters (e.g., t, t1, and t2). For example, the value t may be the time at which the UE 120 starts receiving the downlink message 315. Accordingly, the time window 405 may start at a time of t-t1 and end at a time oft-t2 (e.g., where t1 > t2). In some examples, the UE 120 may receive the values of t1 and t2 as part of the configuration information 305 (e.g., via RRC signaling or MAC-CE signaling).

In some cases, however, the UE 120 may be unable to receive or decode the downlink message 315. For instance, the UE 120 may be unable to receive or decode the downlink message 315 due to poor signal quality or interference, which can result in errors during transmission. Additionally, issues such as incorrect configuration parameters or synchronization problems between the UE 120 and the network node 110 can also prevent successful reception and decoding of the downlink message 315. Therefore, the network node 110 may retransmit the downlink message 315 to the UE 120. However, the content of the downlink message 315 may not change between the initial transmission and the HARQ retransmission of the PDSCH. Hence, the first validation content derived from the one or more DCI transmissions 310 cannot change in the retransmission, even though the time window 405 may shift relative to the timing of the retransmission. Accordingly, the UE 120 and network node 110 may operate in accordance with one or more techniques to enable DCI validation between different HARQ transmissions and retransmissions of the downlink message 315.

In some examples, the network node 110 and the UE 120 may disable HARQ retransmissions (soft combing) for the downlink message 315 based on the downlink message 315 including the first validation content. For instance, the UE 120 may still transmit a NACK if the UE 120 cannot decode the downlink message 315. However, the network node 110 may schedule and transmit a second initial transmission (another downlink transport block) which can include the same data information 325 but different first validation content because the one or more DCIs received during the time window 405 may not be same, as the time window 405 shifts relative to the second initial transmission.

In some examples, if the downlink message 315 is an SPS-PDSCH message, then the one or more DCI transmissions 310 may be determined based on the time occasion (e.g., slot, frame, or system frame number (SFN)) of the SPS-PDSCH message. For instance, HARQ retransmissions for the SPS-PDSCH (dynamically scheduled) may be possible based on the HARQ retransmission of the SPS-PDSCH referencing the initial timing of initial SPS-PDSCH message. Therefore, the time window 405 does not change because the value of t is still with reference to the initial transmission of the SPS-PDSCH message. Additionally, because SPS-PDSCHs are not scheduled by a DCI, there is no ambiguity with reference to determining the time occasion t of the initial transmission of an SPS-PDSCH.

In some examples, the downlink message 315 may indicate the associated time window 405. In other words, the PDSCH message that is embedded with the first validation content may additionally indicate the time window 405 (e.g., indicate t-t1 and t-t2). Based on indicating the start and end of the time window 405 in the downlink message 315, the network node 110 may decouple the time window 405 from the time t that the UE 120 receives the PDSCH. Therefore, the time window 405 does not move across different HARQ retransmissions of the same downlink transport block. Additionally, explicitly indicating the time window 405 in the downlink message 315 may be implemented for multiple types of downlink messages 315 (e.g., not limited to SPS-PDSCHs).

In some cases, however, the UE 120 may be unable to receive or decode a DCI transmission from the one or more DCI transmissions 310. For instance, the network node 110 may have transmitted DCI 1 through DCI n during the time window 405 (e.g., n DCIs). If, for example, the UE 120 missed one of the transmitted DCIs, the first validation content imbedded in the downlink message 315 may not match what the UE 120 derives from the n-1 DCIs received by the UE 120. If the first validation content includes the payloads of all of the transmitted DCIs (which implicitly indicates a number of DCIs) then the UE 120 may be aware of missing a DCI transmission. However, if the first validation content is based on a hashing function of the payloads of the DCIs or an XOR function, then the UE 120 may be unaware of missing a DCI.

Accordingly, the network node 110 may indicate a number of transmitted DCIs in the time window 405 as part of the first validation content embedded in the downlink message 315. If the number of DCIs indicated in the downlink message 315 matches the number of detected DCIs at the UE 120, then the UE 120 performs the integrity check (e.g., performs integrity validation procedure 340). If the number of DCIs indicated in the downlink message 315 is larger than the number of detected DCIs at the UE 120, then the UE 120 skips the integrity check (e.g., UE 120 assumes detected DCIs are not fake), and may report to the network node 110 (e.g., via RRC signaling, MAC-CE signaling, or UCI signaling) that the UE 120 did not receive one or more of the DCIs transmitted during the time window 405. If the number of DCIs indicated in the downlink message 315 is smaller than the number of detected DCIs at the UE 120, the integrity check based on the first validation content may be skipped and the UE 120 may report a potential security issue (detection of fake DCIs) to the network node 110 (e.g., via RRC signaling, MAC-CE signaling, or UCI signaling). Indicating (in the downlink message 315) the number of DCIs transmitted by the network node 110 during the time window 405 may enable the UE 120 to more efficiently determine whether the UE 120 missed DCIs or received additional and potentially fake DCIs, which may increase communication security between the UE 120 and the network node 110.

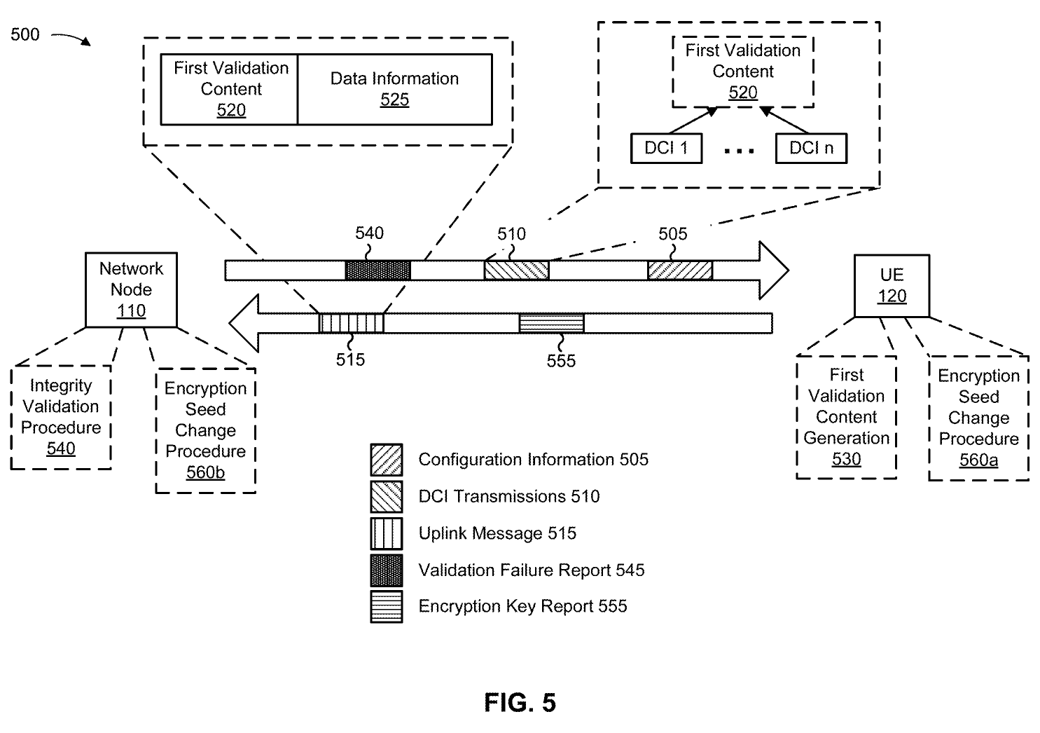

FIG. 5 is a diagram of an example 500 in accordance with uplink messages carrying content for validating DCI transmissions. In some examples, FIG. 5 may implement one or more aspects of FIGS. 1-4. For example, as shown, FIG. 5 includes the UE 120 and the network node 110 described elsewhere herein. Additionally, the DCI transmissions 510 may be examples of the DCI transmissions 210.

As shown in FIG. 5, the network node 110 may transmit, and the UE 120 may receive, configuration information 505. In some examples, the configuration information 505 may be transmitted via one or more of system information (e.g., included MIB or SIB), RRC signaling, MAC signaling (e.g., including one or more MAC-CEs), or DCI signaling. The configuration information 505 may include or indicate one or more parameters described herein that enable integrity validation for DCI transmissions. Further description of the configuration information 505 described elsewhere.

As shown in FIG. 5, the network node 110 may transmit, and the UE 120 may receive, one or more DCI transmissions 510. In example 500, the DCI transmissions 510 include DCI 1 through DCI n, but in other examples, the DCI transmissions 510 may include any number of DCI transmissions.

As shown in FIG. 5, the UE 120 may transmit, and the network node 110 may receive, an uplink message (e.g., an uplink transport block carried via a PUSCH). Additionally, the uplink message 515 may include first validation content 520 and data information 525. As shown in FIG. 5, the first validation content 520 is content derived from the payload of the one or more DCI transmissions 510. For example, the UE 120 may perform a first validation content generation 530 to generate the first validation content. The UE 120 may perform the first validation content generation 530 in accordance with one or more techniques.

In some examples of the first validation content generation 530, the DCI payloads (before CRC attachment) from the one or more DCI transmissions 510 are considered. In some examples, the first validation content 520 may be the concatenated payload combined from each of the one or more DCI transmissions 510 (e.g., the first validation content 520 includes the set of bits of DCI 1 followed by the set of bits of DCI 2, and so on, and ends with the set of bits of DCI n). Concatenating the payloads across the one or more DCI transmissions 510 may reduce complexity in generating the first validation content 520 and enables the first validation content 520 to include information from DCIs of different DCI formats or sizes. In some examples, the UE 120 may perform a bit-wise XOR computation across the one or more payloads of the one or more DCI transmissions 510 (if the DCIs all have a same payload size). For example, “bit-wise XOR computation” refers to an operation that takes multiple binary numbers of equal length and performs the XOR operation on each corresponding pair of bits. The XOR operation outputs a “1” if the corresponding bits are different (one is “0” and the other is “1”) and outputs a “0” if the corresponding bits are the same (both are “0” or both are “1”). Performing the bit-wise XOR computation across the one or more payloads may reduce the size of the first validation content 520, which may reduce signal overhead (if the DCIs are of the same DCI field size).

In some examples of the first validation content generation 530, a specific field from the one or more DCI transmissions 510 may be considered. For example, the UE 120 may use bits from the FDRA field of the DCI transmissions 510, use bits from the TDRA field of the DCI transmissions 510, or some other field of the DCI transmissions 510. In some examples, the first validation content 520 may be the concatenated bits from the specific field from each of the DCI transmissions 510. In some examples, the first validation content 520 may be a bit-wise XOR computation of the bits from the specific field from each of the DCI transmissions 510. By using the bits from a single field of the DCI transmissions 510 (e.g., rather than the full payload) the size of the first validation content 520 may be reduced, reducing signaling overhead.

In some examples of the first validation content generation 530, the CRCs from the one or more DCI transmission 510 may be considered. For example, the UE 120 may use the CRC bits from the DCI transmissions 510 to generate the first validation content. In some examples, the first validation content 520 may be the concatenated bits from the CRCs from each of the DCI transmissions 510. In some examples, the first validation content 520 may be a bit-wise XOR computation of the bits from the CRCs from each of the DCI transmissions 510. By using the bits of the CRCs of the DCI transmissions 510 (e.g., rather than the full payload), the size of the first validation content 520 may be reduced, reducing signaling overhead.

In some examples of the first validation content generation 530, a hashing function may be used. A hashing function may be a mathematical algorithm that takes an input and returns a fixed-size string of bits, such as a hash value. The output is unique to each unique input, making the hashing function useful for verifying data integrity, and is difficult for other wireless devices (such as the aggressor network node 110 205) to reverse engineer. For example, the hashing function may take the payload, a specific field, or the CRC of each of the DCI transmissions 510 as input and derive or output a fixed number of bits to include in the first validation content 520. In some examples, the hashing function may be an authentication function (that may be known to the network node 110 and the UE 120), where the authentication function is based on a security key used by the network node 110 and the UE 120 to encrypt wireless messages. In some examples, the configuration information 505 may indicate the hashing function or the authentication function. In some examples, the configuration information 505 may indicate for the UE 120 to use a currently-in-use security key to generate the hashing function.

After generating the first validation content 520, the UE 120 may include or embed the first validation content 520 into the uplink message 515. In some examples, the first validation content 520 may be at the beginning of the payload for the uplink message 515. In other examples, the first validation content 520 may be at the end of the uplink message 515 or interleaved with the data information 525.

Based on receiving the uplink message 515, the network node 110 may decode and identify the first validation content 520. Accordingly, the network node 110 may perform an integrity validation procedure 540 to identify whether the DCI transmissions 510 are valid. For example, the network node 110 may generate second validation content using the same process and operations performed by the UE 120 during the first validation content generation 530. In some examples, the configuration information 505 may indicate the operations used for the first validation content generation 530, or the operations used may be defined in a wireless communications standard (e.g., 3GPP). If the second validation content matches the first validation content 520, then the network node 110 determines that the DCI transmissions 510 are valid and that the UE 120 did not receive fake DCIs that originated from an aggressor network node 110.

If the second validation content matches the first validation content 520, then the network node 110 may determine that an integrity check of the DCI transmissions 510 failed. Accordingly, the network node 110 may transmit, and the UE 120 may receive, a validation failure report 545. In some examples, the validation failure report 545 may be transmitted via one or more of DCI signaling (e.g., L1), MAC-CE signaling (e.g., L2), or MAC-SDU signaling (e.g., higher layer signaling). In some examples, the validation failure report 545 may include a binary indication (e.g., a single bit) that indicates a potential integrity issue. Indicating a single bit in the validation failure report 545 may reduce signaling overhead. Additionally, or alternatively, the validation failure report 545 may include the first validation content 520. Indicating the first validation content 520 may indicate to the network node 110 that the validation failure report 545 corresponds to the DCI transmissions 510, reducing confusion between the UE 120 and network node 110. Additionally, or alternatively, the validation failure report 545 may include more granular information (e.g., the number of DCI transmissions received by the UE 120 and the first validation content 520). Indicating the more granular information may enable the UE 120 to better identify the cause of the validation failure, which may reduce latency in identifying a potential aggressor network node 110 205 or resolving the validation failure. In some examples, the validation failure report 545 may indicate that the network node 110 has detected a security issue based on the integrity validation procedure 540 failing. In some examples, the network node 110 may perform, with the UE 120, a security establishment procedure based on the integrity validation procedure 540 failing.

In some examples, the PUSCH messages that include the first validation content 520 may be selective (e.g., not present in all PUSCHs to reduce signal overhead). Accordingly, the UE 120 may select to include the first validation content 520 in the uplink message 515 based on one or more characteristics of the uplink message 515. For example, including the first validation content 520 may be enabled for one or more component carriers or one or more HARQ identifiers. In some examples, the configuration information 505 may indicate the one or more component carriers or one or more HARQ identifiers that are enabled. In some examples, the network node 110 may dynamically indicate that a PUSCH should carry validation content. For instance, the network node 110 may transmit, and the UE 120 may receive, a scheduling DCI that schedules the uplink message 515, where the scheduling DCI indicates that the uplink message 515 should include the first validation content 520. In examples where the uplink message 515 is a configured grant (CG)-PUSCH message, the activating DCI (that activates the CG-PUSCH message) may indicate that the uplink message 515 includes the first validation content 520. In some examples, the UE 120 may determine to include the first validation content 520 in the uplink message 515 and may indicate to the network node 110 that the uplink message 515 includes the first validation content 520 (e.g., via RRC signaling, MAC-CE signaling, or UCI signaling)

As described herein, one or more of the UE 120 or network node 110 may detect a security issue. For example, the UE 120 and the network node 110 may detect a security issue based on the integrity validation procedure 540 failing, based on the validation failure report 545, based on the rate of occurrence of the validation failure satisfying the rate of occurrence threshold, or a combination thereof. In some other examples, the UE 120 may determine a security issue that is separate from or independent of the DCI transmissions 510. In other words, a detection mechanism (employed at one or more of the UE 120 or the network node 110) for identifying a security issue is not limited to identifying fake DCI transmissions.

If the UE 120 determines or detects a security issue, then the UE 120 may initiate a seed change that results in updating an encryption key (or security key). For example, an encryption key is a secret value used by both the network node 110 and the UE 120 to encrypt and decrypt messages, ensuring secure communication. The UE 120 may obtain the encryption key through an authentication process configured via the configuration information 505 (e.g., RRC signaling from the network node 110). During this process, the UE 120 and the network node 110 may use an authentication function (configured via the configuration information 505) to generate an encryption key. Accordingly, the UE 120 and the network node 110 may use a first encryption key prior to the UE 120 detecting the security issue. In accordance with identifying the security issue, the UE 120 initiates a seed change (using an encryption seed change procedure 560a) that updates the encryption key. For example, the UE 120 may use one or more parameters or functions (e.g., the authentication function) for deriving the updated encryption key (e.g., a new seed). Therefore, even if an aggressor network node 110 205 identifies that the UE 120 is updating the encryption key, updating the encryption key using the authentication function ensures that the aggressor network node 110 205 is unaware of the updated encryption key.

Additionally, the UE 120 may report updating the encryption key to the network node 110 so that the network node 110 may update the encryption key as well. For example, the UE 120 may transmit an encryption key report 555 (e.g., via RRC signaling, MAC-CE signaling, MAC-SDU signaling, or UCI signaling) that indicates for the network node 110 to update the encryption key. Based on receiving the encryption key report 555, the network node 110 may perform an encryption seed change procedure 560b to derive the second encryption key (e.g., similar to the encryption seed change procedure 560a). In some examples, the timeline for the UE 120 updating from a first encryption key to a second encryption key may be a time (fixed or configurable) after the UE 120 transmits the encryption key report. For instance, the configuration information 505 may indicate or the UE 120 may be pre-configured with a timer, where after expiration of the timer the UE 120 and the network node 110 may start encrypting and decrypting subsequent wireless messages using the second encryption key. Waiting the duration of the timer may enable both the network node 110 and the UE 120 to perform the authentication function to derive the second encryption key such that the network node 110 and the UE 120 may both switch to using the second encryption key at the same time.

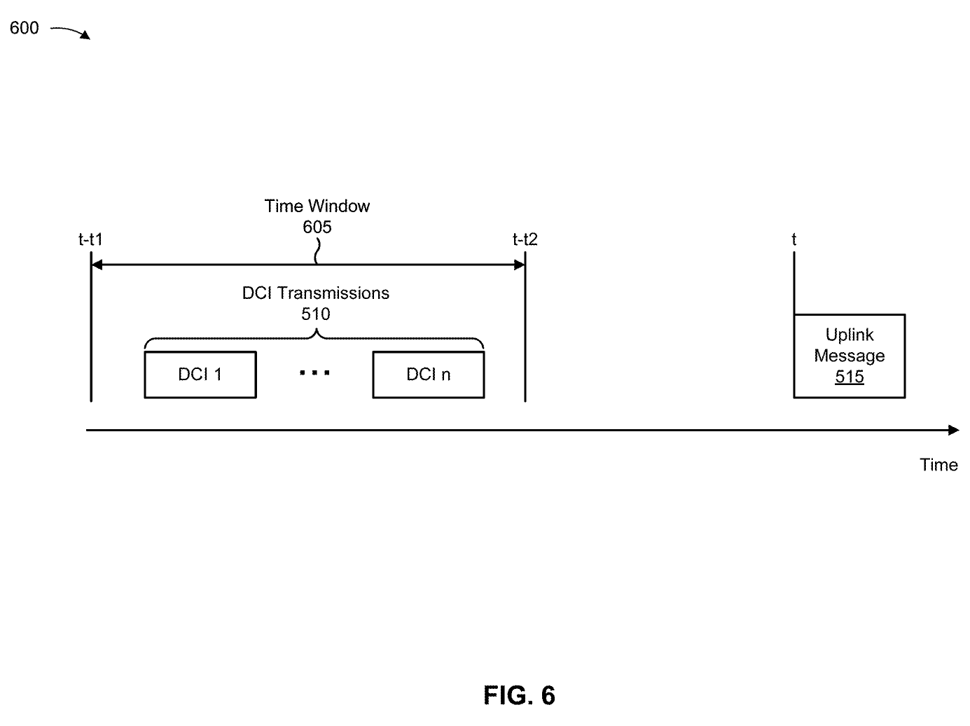

FIG. 6 is a diagram of an example 600 in accordance with identifying DCI transmissions to use for deriving validation content that is included in an uplink message. In some examples, FIG. 6 may implement one or more aspects of FIGS. 1-5. For example, as shown, FIG. 6 includes wireless communications between the UE 120 and the network node 110 described elsewhere herein. For instance, FIG. 6 shows a timing diagram of the UE 120 receiving DCI 1 through DCI n (e.g., DCI transmissions 510) and the UE 120 transmitting the uplink message 515. As shown in FIG. 6, the one or more DCI transmissions 510 may fall within a time window 605. The configuration of the time window 605 is described herein.

In some examples, the one or more DCI transmissions 510 may have one or more of the same DCI format or same DCI size. For instance, in one example, the network node 110 and the UE 120 may only consider uplink grants to use for deriving the first validation content (e.g., DCI formats scheduling uplink transport blocks). In other words, non-uplink grant DCIs that are received by the UE 120 within the time window 605 are not considered part of the one or more DCI transmissions 510. Alternatively, in one example, the network node 110 and the UE 120 may only consider DCIs scheduling initial uplink or downlink transmissions for deriving the first validation content (e.g., not consider DCIs scheduling HARQ retransmissions). Considering DCIs of the same DCI format or same DCI size may enable the network node 110 and UE 120 to focus on validating specific types of DCIs rather than validating all DCI communications, which may reduce complexity for deriving the first validation content and performing the integrity validation procedure 540. In some examples, the network node 110 and the UE 120 may concurrently perform separate or independent DCI validation procedures for DCIs of different sizes or formats (e.g., a first DCI validation procedure for downlink grant DCIs and a second DCI validation procedure for DCIs scheduling initial uplink or downlink transmissions).

In some examples, the one or more DCI transmissions 510 may have one or more of the same DCI format or the same DCI size. In other words, any DCI received by the UE 120 during the time window 605 may be considered part of the one or more DCI transmissions 510.

In some examples, the DCI that schedules the uplink message 515 (if the uplink message 515 is not a CG-PUSCH message) may or may not be included as part of the one or more DCI transmissions 510. In some examples, the scheduling DCI is part of the one or more DCI transmissions 510 if the UE 120 receives the scheduling DCI during the time window 605. In some examples, whether the scheduling DCI is part of the one or more DCI transmissions 510 is based on a scheduling offset (K2) between the scheduling DCI and the uplink message 515. For instance, if K2 is greater than zero, then the scheduling DCI is included in the one or more DCI transmissions 510, and if K2 is equal to zero, then the scheduling DCI is not included in the one or more DCI transmissions 510. In some examples, the value of K2 may be indicated via the scheduling DCI.

In some examples, the time window 605 may be based on a set of timing parameters (e.g., t, t1, and t2). For example, the value t may be the time at which the UE 120 starts receiving the uplink message 515. Accordingly, the time window 605 may start at a time of t-t1 and end at a time of t-t2 (e.g., where t1 > t2). In some examples, the UE 120 may receive the values of t1 and t2 as part of the configuration information 505 (e.g., via RRC signaling or MAC-CE signaling).

In some cases, however, the network node 110 may be unable to receive or decode the uplink message 515. For instance, the network node 110 may be unable to receive or decode the uplink message 515 due to poor signal quality or interference, which can result in errors during transmission. Additionally, issues such as incorrect configuration parameters or synchronization problems between the UE 120 and the network node 110 can also prevent successful reception and decoding of the uplink message 515. Therefore, the UE 120 may retransmit the uplink message 515 to the network node 110. However, the content of the uplink message 515 may not change between the initial transmission and the HARQ retransmission of the PUSCH. Hence, the first validation content derived from the one or more DCI transmissions 510 cannot change in the retransmission, even though the time window 605 may shift relative to the timing of the retransmission. Accordingly, the UE 120 and network node 110 may operate in accordance with one or more techniques to enable DCI validation between different HARQ transmissions and retransmissions of the uplink message 515.

In some examples, the network node 110 and the UE 120 may disable HARQ retransmissions (soft combing) for the uplink message 515 based on the uplink message 515 including the first validation content. For instance, if the network node 110 cannot decode the uplink message 515, then the network node 110 may schedule for the UE 120 to transmit a second initial transmission (another uplink transport block) which can include the same data information 525 but different first validation content because the one or more DCIs received during the time window 605 may not be same as the time window 605 shifts relative to the second initial transmission.

In some examples, if the uplink message 515 is a CG-PUSCH message, then the one or more DCI transmissions 510 may be determined based on the time occasion (e.g., slot, frame, or SFN) of the CG-PUSCH message. For instance, HARQ retransmissions for the CG-PUSCH (dynamically scheduled) may be possible based on the HARQ retransmission of the CG-PUSCH referencing the initial timing of initial CG-PUSCH message. Therefore, the time window 605 does not change because the value of t is still with reference to the initial transmission of the CG-PUSCH message. Additionally, because CG-PUSCHs are not scheduled by a DCI, there is no ambiguity with reference to determining the time occasion t of the initial transmission of an CG-PUSCH.

In some examples, the uplink message 515 may indicate the associated time window 605. In other words, the PUSCH message that is embedded with the first validation content may additionally indicate the time window 605 (e.g., indicate t-t1 and t-t2). Based on indicating the start and end of the time window 605 in the uplink message 515, the UE 120 may decouple the time window 605 from the time t that the network node 110 receives the PUSCH. Therefore, the time window 605 does not move across different HARQ retransmissions of the same uplink transport block. Additionally, explicitly indicating the time window 605 in the uplink message 515 may be implemented for multiple types of uplink messages 515 (e.g., not limited to CG-PUSCHs).

In some cases, however, the UE 120 may be unable to receive or decode a DCI transmission from the one or more DCI transmissions 510. For instance, the network node 110 may have transmitted DCI 1 through DCI n during the time window 605 (e.g., n DCIs). If, for example, the UE 120 missed one of the transmitted DCIs, then the first validation content embedded in the uplink message 515 may not match what the network node derives from the n DCIs transmitted to the UE 120. If the first validation content includes the payloads of all of the transmitted DCIs (which implicitly indicates a number of DCIs) then the network node may be aware if the UE 120 misses a DCI transmission. However, if the first validation content is based on a hashing function of the payloads of the DCIs or an XOR function, then the network node 110 may be unaware if the UE misses a DCI transmission.

Accordingly, the UE 120 may indicate a number of transmitted DCIs received during the time window 605 as part of the first validation content embedded in the uplink message 515. If the number of DCIs indicated in the uplink message 515 matches the number DCIs transmitted by the network node 110 during the time window 605, then the network node 110 performs the integrity check (e.g., performs integrity validation procedure 540). If the number of DCIs indicated in the uplink message 515 is smaller than the number DCIs transmitted by the network node 110 during the time window 605, then the network node 110 skips the integrity check and may report to the UE 120 (e.g., via RRC signaling, MAC-CE signaling, or DCI signaling) that the UE 120 did not receive one or more of the DCIs transmitted during the time window 605. If the number of DCIs indicated in the uplink message 515 is greater than the number DCIs transmitted by the network node 110 during the time window 605, an integrity check based on the first validation content may be skipped and the network node 110 may report a potential security issue (detection of fake DCIs) to the UE 120 (e.g., via RRC signaling, MAC-CE signaling, or DCI signaling). Indicating (in the uplink message 515) the number of DCIs received by the UE 120 during the time window 605 may enable the network node 110 to more efficiently determine whether the UE 120 missed DCIs or received additional and potentially fake DCIs, which may increase communication security between the UE 120 and the network node 110.

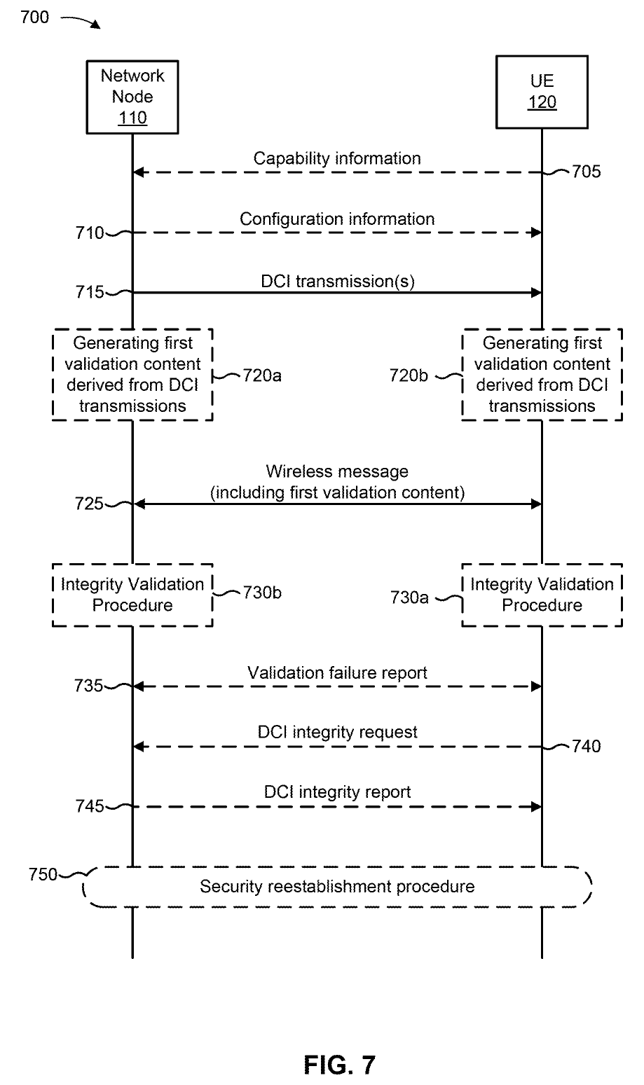

FIG. 7 is a diagram illustrating an example 700 associated with signaling that enables content validation of DCI transmissions. Example 700 may implement or be implemented by one or more aspects of FIGS. 1-6. For instance, example 700 includes wireless communications between the network node 110 and the UE 120. Alternative examples of the following may be implemented, where some operations are performed in a different order than described, or not described at all. In some cases, one or more operations may include additional features not mentioned below, or further operations may be added. In addition, while example 700 shows operations between the UE 120 and the network node 110, the communications may occur between any number of network devices of various types described herein.

In a first operation 705, the UE 120 may optionally transmit, and the network node 110 may receive, capability information. The capability information may be included in a capability report. The UE 120 may transmit the capability information via an uplink communication, a sidelink communication, a unicast communication, a broadcast communication, a UE 120 assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), or a physical sidelink shared channel (PSSCH)), among other examples. The capability information may indicate one or more parameters associated with respective capabilities of the UE 120. The one or more parameters may be indicated via respective information elements (IEs) included in a capability report.

The capability information may indicate whether the UE 120 supports a feature or one or more parameters related to the feature. In some examples, the capability information may indicate a capability of the UE 120 to support validating DCI transmissions (e.g., can perform the integrity validation procedure 340). In some examples, the capability information may indicate a capability or parameter that the UE 120 supports deriving validation content from DCI transmissions to include in uplink messages (e.g., can perform the first validation content generation 530). One or more operations described herein may be based on the capability information. For example, the UE 120 may perform one or more operations of example 700 in accordance with the capability information or may receive one or more of configuration information or control information that is in accordance with the capability information. The network node 110 may determine configuration information for the UE 120 based on the capability information.

In a second operation 710, the network node 110 may transmit, and the UE 120 may receive, the configuration information (e.g., one or more of the configuration information 305 or 505). In some aspects, the UE 120 may receive the configuration information via one or more of system information signaling (e.g., a MIB or a SIB, among other examples), RRC signaling, MAC signaling (e.g., one or more MAC-CEs), or DCI, among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may indicate a candidate configuration or communication parameter from the one or more candidate configurations or communication parameters. In some aspects, the subsequent indication may include a dynamic indication, such as one or more MAC-CEs or one or more DCI messages, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some examples, the configuration information may indicate a time window that defines which DCI transmissions to use for deriving the first validation content (e.g., indicated in one or more of the time windows 405 or 605). In some examples, the configuration information may indicate which wireless messages are enabled to carry the first validation content (e.g., PDSCH messages or PUSCH messages). Additionally, or alternatively, the configuration information may include one or more indications included in one or more of the configuration information 305 or 505.

In a third operation 715, the network node 110 may transmit, and the UE 120 may receive, one or more DCI transmissions (e.g., DCI transmissions 310 and 510). In some examples, the one or more DCI transmissions may have one or more of a same DCI format or a same DCI size, where separate integrity validation procedures may be applied independently for different DCI formats or different DCI sizes. In some examples, the one or more DCI transmissions may have one or more different DCI formats or different DCI sizes, where one integrity validation procedure may be applied for the one or more DCI transmissions. In some examples, the one or more DCI transmissions are within a time window, where a start time of the time window and an end time of the time window may both be defined relative to a start time of a wireless message (e.g., the downlink message 315 or the uplink message 515).

In a fourth operation 720, the network node 110 or the UE 120 may generate first validation content derived from the one or more DCI transmissions. For instance, if the first validation content is to be transmitted via a downlink message, then the network node 110 may perform a fourth operation 720a, where the network node 110 generates the first validation content derived from the one or more DCI transmissions (e.g., perform the first validation content generation 330). If the first validation content is to be transmitted via an uplink message, then the UE 120 may perform a fourth operation 720b, where the UE 120 generates the first validation content derived from the one or more DCI transmissions (e.g., perform the first validation content generation 530).

In some examples, the first validation content may be derived from one or more DCI payloads respectively from the one or more DCI transmissions before a CRC attachment, one or more DCI fields respectively from the one or more DCI transmissions, one or more CRCs respectively from the one or more DCI transmissions, or a hashing function that uses the payload of the one or more DCI transmissions as an input and outputs a fixed number of bits that comprises the first validation content, or a combination thereof.

In a fifth operation 725, the UE 120 may communicate, with the network node 110, the wireless message. As described herein, the wireless message may include the first validation content derived from a payload of the one or more DCI transmissions and the first validation content may be used for an integrity validation of the one or more DCI transmissions.

In some examples, the wireless message includes the first validation content based on one or more of a component carrier of the wireless message, a HARQ identifier of the wireless message, or an indication included in a DCI that schedules or activates the wireless message.

In some examples, HARQ retransmissions are disabled for the wireless message. In some examples, if the wireless message is a CG-PUSCH or an SPS-PDSCH, then the one or more DCI transmissions that the first validation content is derived from may be based on a time occasion of the wireless message. In some examples, the wireless message may indicate the time window (e.g., time window 405 or 605), where the one or more DCI transmissions are used to derive the first validation content based on being within the time window. In some examples, a number of DCI transmissions included in the one or more DCI transmissions may be indicated in the first validation content included in the wireless message.

In a sixth operation 730, the network node 110 or the UE 120 may perform an integrity validation procedure. For instance, if the wireless message is the downlink message 315, then (in a sixth operation 730a) the UE 120 may generate second validation content derived from the payload of the one or more DCI transmissions, where the integrity validation may be based on comparing the second validation content to the first validation content (e.g., perform the integrity validation procedure 340). Alternatively, if the wireless message is the uplink message 515, then (in a sixth operation 730b) the network node 110 may generate second validation content derived from the payload of the one or more DCI transmissions, where the integrity validation may be based on comparing the second validation content to the first validation content (e.g., perform the integrity validation procedure 540).

In a seventh operation 735, the UE 120 may optionally communicate, with the network node 110, a validation failure report (e.g., the validation failure reports 345 or 545). For example, the validation failure report may indicate that the integrity validation failed if the second validation content did not match the first validation content. In some examples, the validation failure report indicates that the integrity validation failed based on indicating one or more of a binary indication, the second validation content, or a number of DCI transmissions included in the one or more DCI transmissions.

In an eighth operation 740, the UE 120 may optionally transmit, and the network node 110 may receive, a request for a DCI integrity report (e.g., the DCI integrity request 350). For example, the UE 120 may transmit the request based on identifying a likelihood metric satisfying a likelihood threshold. The likelihood metric may correspond to at least one DCI transmission of the one or more DCI transmissions not originating from the network node 110.

In a ninth operation 745, the network node 110 may optionally transmit, and the UE 120 may receive, a DCI integrity report (e.g., the DCI integrity report 355). The DCI integrity report may include integrity information for the one or more DCI transmissions (e.g., may include the first validation content).

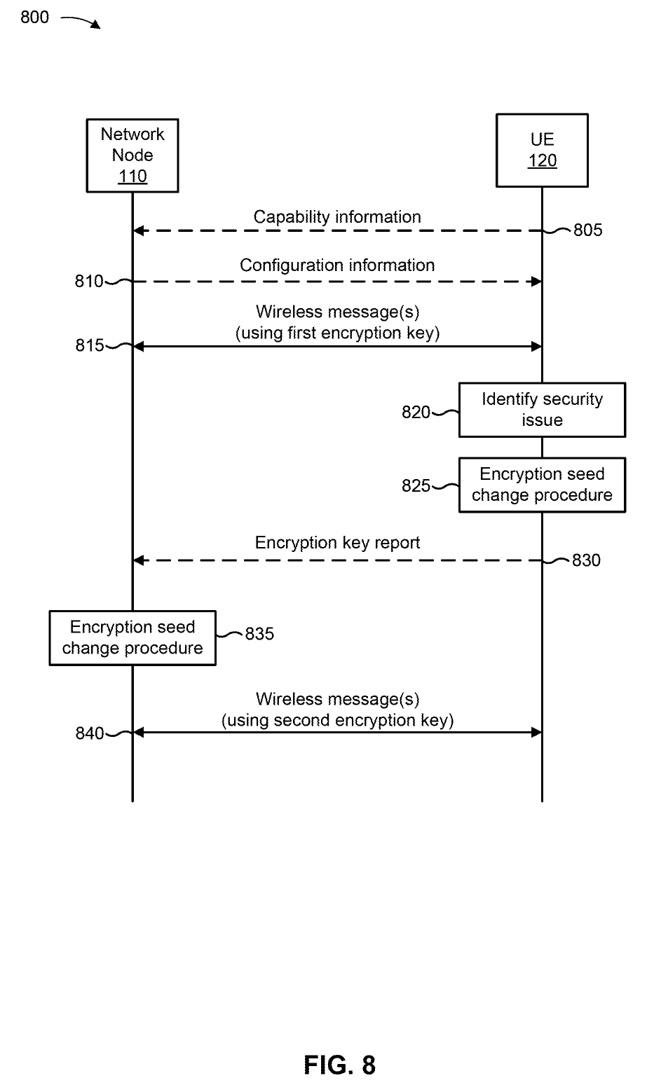

In a tenth operation 750, the UE 120 and the network node 110 may optionally perform a security reestablishment procedure. In some examples, the security reestablishment procedure is performed based on one or more of the UE 120 or network node 110 identifying the integrity validation failing. In some examples, the security reestablishment procedure is performed based on one or more of the UE 120 or network node 110 identifying a security issue based on a rate of detected integrity validation failures satisfying a rate threshold. One or more aspects of the security reestablishment procedure are described elsewhere herein (e.g., including with reference to FIG. 8).

FIG. 8 is a diagram illustrating an example 800 associated with signaling that enables a security reestablishment procedure. Example 800 may implement or be implemented by one or more aspects of FIGS. 1-7. For instance, example 800 includes wireless communications between the network node 110 and the UE 120. Additionally, one or more operations of example 800 may be part of or correspond to the security reestablishment procedure (e.g., in the tenth operation 750 of FIG. 7). Alternative examples of the following may be implemented, where some operations are performed in a different order than described, or not described at all. In some cases, one or more operations may include additional features not mentioned below, or further operations may be added. In addition, while example 800 shows operations between the UE 120 and the network node 110, the communications may occur between any number of network devices of various types described herein.

In a first operation 805, the UE 120 may optionally transmit, and the network node 110 may receive, capability information. The capability information may be included in a capability report. The UE 120 may transmit the capability information via an uplink communication, a sidelink communication, a unicast communication, a broadcast communication, a UAI communication, a UCI communication, an SCI communication, a MAC-CE communication, an RRC communication, a PUCCH, a PUSCH, or a sidelink channel (e.g., a PSCCH, or a PSSCH), among other examples. The capability information may indicate one or more parameters associated with respective capabilities of the UE 120. The one or more parameters may be indicated via respective IEs included in a capability report.

The capability information may indicate whether the UE 120 supports a feature or one or more parameters related to the feature. In some examples, the capability information may indicate a capability or parameter that the UE 120 supports generating an updated encryption key based on identifying a potential security issue for communications between the network node 110 and the UE 120. One or more operations described herein may be based on the capability information. For example, the UE 120 may perform one or more operations of example 800 in accordance with the capability information or may receive one or more of configuration information or control information that is in accordance with the capability information. The network node 110 may determine configuration information for the UE 120 based on the capability information.

In a second operation 810, the network node 110 may optionally transmit, and the UE 120 may receive, the configuration information (e.g., one or more of the configuration information 305 or 505). In some aspects, the UE 120 may receive the configuration information via one or more of system information signaling (e.g., a MIB or a SIB, among other examples), RRC signaling, MAC signaling (e.g., one or more MAC-CEs), or DCI, among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may indicate a candidate configuration or communication parameter from the one or more candidate configurations or communication parameters. In some aspects, the subsequent indication may include a dynamic indication, such as one or more MAC-CEs or one or more DCI messages, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some examples, the configuration information may indicate an authentication function used for generating one or more encryption keys. In some examples, the configuration information may indicate a timer associated with updating an encryption key based on identifying a security issue. Additionally, or alternatively, the configuration information may include one or more indications included in one or more of the configuration information 305 or 505.

In a third operation 815, the UE 120 may communicate, with the network node 110, one or more wireless messages that are encrypted using a first encryption key. For example, the one or more wireless messages may be examples of PUSCH messages or PDSCH messages, among other message types.

In a fourth operation 820, the UE 120 may identify a security issue associated with the one or more wireless messages. In some examples, the UE 120 may identify the security issue based on a content validation failure for one or more DCI transmissions, as described elsewhere herein. Additionally, or alternatively, the UE 120 may identify the security issue based one or more characteristics of communications between the network node 110 and the UE 120.

In a fifth operation 825, the UE 120 may perform an encryption seed change procedure (e.g., the encryption seed change procedures 360aor 560a). For example, the encryption seed change procedure may generate a second encryption key based on identifying the security issue associated with the one or more wireless messages. In some examples, the encryption seed change procedure includes the authentication function for generating one or more encryption keys.

In a sixth operation 830, the UE 120 may transmit, and the network node 110 may receive, a report that indicates an update from using the first encryption key to using the second encryption key (e.g., the encryption key report 365 or 555).

In a seventh operation 835, the network node 110 may perform an encryption seed change procedure based on receiving the encryption key report (e.g., perform the encryption seed change procedures 360b or 560b). In some examples, the encryption seed change procedure includes the authentication function for generating one or more encryption keys.

In an eighth operation 840, the UE 120 and the network node 110 may communicate a wireless message using the second encryption key. In some examples, the UE 120 and the network node 110 may wait to communicate wireless messages using the second encryption key until after the timer expires. For example, after the UE 120 transmits the encryption key report, the UE 120 may start the timer and wait until expiration of the timer to begin encrypting and decrypting wireless messages using the second encryption key. Waiting until after expiration of the timer enables the network node 110 to perform the encryption seed change procedure, such that the UE 120 and the network node 110 may be updated to using the second encryption key at the same time.

FIG. 9 is a diagram illustrating an example process 900 performed, for example, at a UE or an apparatus of a UE. Example process 900 is an example where the apparatus or the UE (e.g., UE 120) performs operations associated with integrity validation for downlink control information transmissions.

As shown in FIG. 9, in some aspects, process 900 may include receiving, from a network node, one or more DCI transmissions (block 910). For example, the UE (e.g., using reception component 1302 or communication manager 1306, depicted in FIG. 13) may receive, from a network node, one or more DCI transmissions, as described above.

As further shown in FIG. 9, in some aspects, process 900 may include communicating, with the network node, a wireless message, where the wireless message comprises first validation content derived from a payload of the one or more DCI transmissions, and the first validation content is used for an integrity validation of the one or more DCI transmissions (block 920). For example, the UE (e.g., using reception component 1302, transmission component 1304, or communication manager 1306, depicted in FIG. 13) may communicate, with the network node, a wireless message, where the wireless message comprises first validation content derived from a payload of the one or more DCI transmissions, and the first validation content is used for an integrity validation of the one or more DCI transmissions, as described above.

Process 900 may include additional aspects, such as any single aspect or any combination of aspects described below or in connection with one or more other processes described elsewhere herein.

In a first aspect, the wireless message is a downlink transport block received from the network node, and process 900 includes generating second validation content derived from the payload of the one or more DCI transmissions, where the integrity validation is based at least in part on comparing the second validation content to the first validation content.

In a second aspect, alone or in combination with the first aspect, process 900 includes transmitting, to the network node, a report indicating that the integrity validation failed based at least in part on the second validation content not matching the first validation content.

In a third aspect, alone or in combination with one or more of the first and second aspects, the report indicates the integrity validation failed based at least in part on indicating one or more of a binary indication, the second validation content, or a number of DCI transmissions included in the one or more DCI transmissions.

In a fourth aspect, alone or in combination with one or more of the first through third aspects, process 900 includes identifying a security issue based at least in part on a rate of detected integrity validation failures satisfying a rate threshold.

In a fifth aspect, alone or in combination with one or more of the first through fourth aspects, the wireless message is an uplink transport block transmitted to the network node, and process 900 includes generating the first validation content derived from the payload of the one or more DCI transmissions, where the first validation content is included in the uplink transport block for the network node to perform the integrity validation.

In a sixth aspect, alone or in combination with one or more of the first through fifth aspects, process 900 includes performing, with the network node, a security reestablishment procedure based at least in part on the integrity validation failing.

In a seventh aspect, alone or in combination with one or more of the first through sixth aspects, process 900 includes receiving, from the network node, a report indicating that the integrity validation failed.

In an eighth aspect, alone or in combination with one or more of the first through seventh aspects, the one or more DCI transmissions have one or more of a same DCI format or a same DCI size, and separate integrity validation procedures are applied independently for different DCI formats or different DCI sizes.

In a ninth aspect, alone or in combination with one or more of the first through eighth aspects, the one or more DCI transmissions have one or more different DCI formats or different DCI sizes, and one integrity validation procedure is applied for the one or more DCI transmissions.

In a tenth aspect, alone or in combination with one or more of the first through ninth aspects, the one or more DCI transmissions are within a time window, and a start time of the time window and an end time of the time window are both defined relative to a start time of the wireless message.

In an eleventh aspect, alone or in combination with one or more of the first through tenth aspects, process 900 includes receiving, from the network node, configuration information that indicates the time window.

In a twelfth aspect, alone or in combination with one or more of the first through eleventh aspects, the wireless message includes the first validation content based at least in part on one or more of a component carrier of the wireless message, a HARQ identifier of the wireless message, or an indication included in a DCI that schedules or activates the wireless message.

In a thirteenth aspect, alone or in combination with one or more of the first through twelfth aspects, the first validation content is derived from one or more DCI payloads respectively from the one or more DCI transmissions before a CRC attachment, one or more DCI fields respectively from the one or more DCI transmissions, one or more CRCs respectively from the one or more DCI transmissions, or a hashing function that uses the payload of the one or more DCI transmissions as an input and outputs a fixed number of bits that comprises the first validation content.

In a fourteenth aspect, alone or in combination with one or more of the first through thirteenth aspects, automatic repeat request retransmissions are disabled for the wireless message.

In a fifteenth aspect, alone or in combination with one or more of the first through fourteenth aspects, the wireless message is a CG-PUSCH or an SPS-PDSCH, and the one or more DCI transmissions that the first validation content is derived from are based at least in part on a time occasion of the wireless message.

In a sixteenth aspect, alone or in combination with one or more of the first through fifteenth aspects, the wireless message indicates a time window, and the one or more DCI transmissions are used to derive the first validation content based at least in part on being within the time window.

In a seventeenth aspect, alone or in combination with one or more of the first through sixteenth aspects, a number of DCI transmissions included in the one or more DCI transmissions is included in the first validation content included in the wireless message.

In an eighteenth aspect, alone or in combination with one or more of the first through seventeenth aspects, process 900 includes transmitting, to the network node, a request for a DCI integrity report based at least in part on identifying a likelihood metric satisfying a likelihood threshold, where the likelihood metric corresponds to at least one DCI transmission of the one or more DCI transmissions not originating from the network node, and receiving, from the network node, the DCI integrity report that includes integrity information for the one or more DCI transmissions.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a UE or an apparatus of a UE. Example process 1000 is an example where the apparatus or the UE (e.g., UE 120) performs operations associated with integrity validation for downlink control information transmissions.

As shown in FIG. 10, in some aspects, process 1000 may include communicating, with a network node, one or more wireless messages that are encrypted using a first encryption key (block 1010). For example, the UE (e.g., using reception component 1302, transmission component 1304, or communication manager 1306, depicted in FIG. 13) may communicate, with a network node, one or more wireless messages that are encrypted using a first encryption key, as described above.

As further shown in FIG. 10, in some aspects, process 1000 may include performing an encryption seed change procedure that generates a second encryption key based at least in part on identifying a security issue associated with the one or more wireless messages (block 1020). For example, the UE (e.g., using communication manager 1306, depicted in FIG. 13) may perform an encryption seed change procedure that generates a second encryption key based at least in part on identifying a security issue associated with the one or more wireless messages, as described above.

As further shown in FIG. 10, in some aspects, process 1000 may include transmitting, to the network node, a report that indicates an update from using the first encryption key to using the second encryption key (block 1030). For example, the UE (e.g., using transmission component 1304 or communication manager 1306, depicted in FIG. 13) may transmit, to the network node, a report that indicates an update from using the first encryption key to using the second encryption key, as described above.

Process 1000 may include additional aspects, such as any single aspect or any combination of aspects described below or in connection with one or more other processes described elsewhere herein.

In a first aspect, the encryption seed change procedure includes an authentication function for generating one or more encryption keys.

In a second aspect, alone or in combination with the first aspect, process 1000 includes receiving, from the network node prior to performing the encryption seed change procedure, configuration information that indicates the authentication function.

In a third aspect, alone or in combination with one or more of the first and second aspects, process 1000 includes communicating, with the network node, a wireless message encrypted using the second encryption key based at least in part on a timer expiring, where the timer is initiated in accordance with transmitting the report.

In a fourth aspect, alone or in combination with one or more of the first through third aspects, process 1000 includes receiving, from the network node, configuration information that indicates the timer.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node. Example process 1100 is an example where the apparatus or the network node (e.g., network node 110) performs operations associated with integrity validation for downlink control information transmissions.

As shown in FIG. 11, in some aspects, process 1100 may include transmitting, to a UE, one or more DCI transmissions (block 1110). For example, the network node (e.g., using transmission component 1404 or communication manager 1406, depicted in FIG. 14) may transmit, to a UE, one or more DCI transmissions, as described above.

As further shown in FIG. 11, in some aspects, process 1100 may include communicating, with the UE, a wireless message, where the wireless message comprises first validation content derived from a payload of the one or more DCI transmissions, and the first validation content is used for an integrity validation of the one or more DCI transmissions (block 1120). For example, the network node (e.g., using reception component 1402, transmission component 1404, or communication manager 1406, depicted in FIG. 14) may communicate, with the UE, a wireless message, where the wireless message comprises first validation content derived from a payload of the one or more DCI transmissions, and the first validation content is used for an integrity validation of the one or more DCI transmissions, as described above.

Process 1100 may include additional aspects, such as any single aspect or any combination of aspects described below or in connection with one or more other processes described elsewhere herein.

In a first aspect, the wireless message is an uplink transport block received from the UE, the process 1100 may include generating second validation content derived from the payload of the one or more DCI transmissions, where the integrity validation is based at least in part on comparing the second validation content to the first validation content.

In a second aspect, alone or in combination with the first aspect, process 1100 includes transmitting, to the UE, a report indicating that the integrity validation failed based at least in part on the second validation content not matching the first validation content.

In a third aspect, alone or in combination with one or more of the first and second aspects, the report indicates the integrity validation failed based at least in part on indicating one or more of a binary indication, the second validation content, or a number of DCI transmissions included in the one or more DCI transmissions.

In a fourth aspect, alone or in combination with one or more of the first through third aspects, process 1100 includes identifying a security issue based at least in part on a rate of detected integrity validation failures satisfying a rate threshold.

In a fifth aspect, alone or in combination with one or more of the first through fourth aspects, the wireless message is a downlink transport block transmitted to the network node, process 1100 includes generating the first validation content derived from the payload of the one or more DCI transmissions, where the first validation content is included in the downlink transport block for the UE to perform the integrity validation.

In a sixth aspect, alone or in combination with one or more of the first through fifth aspects, process 1100 includes performing, with the UE, a security reestablishment procedure based at least in part on the integrity validation failing.

In a seventh aspect, alone or in combination with one or more of the first through sixth aspects, process 1100 includes receiving, from the UE, a report indicating that the integrity validation failed.

In an eighth aspect, alone or in combination with one or more of the first through seventh aspects, the one or more DCI transmissions have one or more of a same DCI format or a same DCI size, and separate integrity validation procedures are applied independently for different DCI formats or different DCI sizes.

In a ninth aspect, alone or in combination with one or more of the first through eighth aspects, the one or more DCI transmissions have one or more different DCI formats or different DCI sizes, and one integrity validation procedure is applied for the one or more DCI transmissions.

In a tenth aspect, alone or in combination with one or more of the first through ninth aspects, the one or more DCI transmissions are within a time window, and a start time of the time window and an end time of the time window are both defined relative to a start time of the wireless message.

In an eleventh aspect, alone or in combination with one or more of the first through tenth aspects, process 1100 includes transmitting, to the UE, configuration information that indicates the time window.

In a twelfth aspect, alone or in combination with one or more of the first through eleventh aspects, the wireless message includes the first validation content based at least in part on one or more of a component carrier of the wireless message, a HARQ identifier of the wireless message, or an indication included in a DCI that schedules or activates the wireless message.

In a thirteenth aspect, alone or in combination with one or more of the first through twelfth aspects, the first validation content is derived from one or more DCI payloads respectively from the one or more DCI transmissions before a CRC attachment, one or more DCI fields respectively from the one or more DCI transmissions, one or more CRCs respectively from the one or more DCI transmissions, or a hashing function that uses the payload of the one or more DCI transmissions as an input and outputs a fixed number of bits that comprises the first validation content.

In a fourteenth aspect, alone or in combination with one or more of the first through thirteenth aspects, automatic repeat request retransmissions are disabled for the wireless message.

In a fifteenth aspect, alone or in combination with one or more of the first through fourteenth aspects, the wireless message is a CG-PUSCH or an SPS-PDSCH, and the one or more DCI transmissions that the first validation content is derived from are based at least in part on a time occasion of the wireless message.

In a sixteenth aspect, alone or in combination with one or more of the first through fifteenth aspects, the wireless message indicates a time window, and the one or more DCI transmissions are used to derive the first validation content based at least in part on being within the time window.

In a seventeenth aspect, alone or in combination with one or more of the first through sixteenth aspects, a number of DCI transmissions included in the one or more DCI transmissions is included in the first validation content included in the wireless message.

In an eighteenth aspect, alone or in combination with one or more of the first through seventeenth aspects, process 1100 includes receiving, from the UE, a request for a DCI integrity report for the one or more DCI transmissions, and transmitting, to the UE, the DCI integrity report that includes integrity information for the one or more DCI transmissions.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node. Example process 1200 is an example where the apparatus or the network node (e.g., network node 110) performs operations associated with integrity validation for downlink control information transmissions.

As shown in FIG. 12, in some aspects, process 1200 may include communicating, with a UE, one or more wireless messages that are encrypted using a first encryption key (block 1210). For example, the network node (e.g., using reception component 1402, transmission component 1404, or communication manager 1406, depicted in FIG. 14) may communicate, with a UE, one or more wireless messages that are encrypted using a first encryption key, as described above.

As further shown in FIG. 12, in some aspects, process 1200 may include receiving, from the UE, a report that indicates an update from using the first encryption key to using a second encryption key (block 1220). For example, the network node (e.g., using reception component 1402 or communication manager 1406, depicted in FIG. 14) may receive, from the UE, a report that indicates an update from using the first encryption key to using a second encryption key, as described above.

As further shown in FIG. 12, in some aspects, process 1200 may include performing an encryption seed change procedure that generates the second encryption key based at least in part on receiving the report (block 1230). For example, the network node (e.g., using communication manager 1406, depicted in FIG. 14) may perform an encryption seed change procedure that generates the second encryption key based at least in part on receiving the report, as described above.

Process 1200 may include additional aspects, such as any single aspect or any combination of aspects described below or in connection with one or more other processes described elsewhere herein.

In a first aspect, the encryption seed change procedure includes an authentication function for generating one or more encryption keys.

In a second aspect, alone or in combination with the first aspect, process 1200 includes transmitting, to the UE prior to receiving the report, configuration information that indicates the authentication function.

In a third aspect, alone or in combination with one or more of the first and second aspects, process 1200 includes communicating, with the UE, a wireless message encrypted using the second encryption key based at least in part on a timer expiring, where the timer is initiated in accordance with transmitting the report.

In a fourth aspect, alone or in combination with one or more of the first through third aspects, process 1200 includes transmitting, to the UE, configuration information that indicates the timer.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE, or a UE may include the apparatus 1300. In some aspects, the apparatus 1300 includes a reception component 1302, a transmission component 1304, or a communication manager 1306, which may be in communication with one another (for example, via one or more buses or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 140 described in connection with FIG. 1) of the UE.

In some aspects, the apparatus 1300 may be configured to perform one or more operations described herein in connection with FIGS. 2-8. Additionally, or alternatively, the apparatus 1300 may be configured to perform one or more processes described herein, such as process 900 of FIG. 9, process 1000 of FIG. 10, or a combination thereof. In some aspects, the apparatus 1300 or one or more components shown in FIG. 13 may include one or more components of the UE described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the UE described above in connection with FIG. 1, such as a radio, one or more RF chains, one or more transceivers, or one or more modems, each of which may in turn be coupled with one or more antennas of the UE.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1304 may be co-located with the reception component 1302.

The communication manager 1306 may support operations of the reception component 1302 or the transmission component 1304. For example, the communication manager 1306 may receive information associated with configuring reception of communications by the reception component 1302 or transmission of communications by the transmission component 1304. Additionally, or alternatively, the communication manager 1306 may generate or provide control information to the reception component 1302 or the transmission component 1304 to control reception or transmission of communications.

The reception component 1302 may receive, from a network node, one or more DCI transmissions. The reception component 1302 or the transmission component 1304 may communicate, with the network node, a wireless message, wherein the wireless message comprises first validation content derived from a payload of the one or more DCI transmissions, and wherein the first validation content is used for an integrity validation of the one or more DCI transmissions.

The transmission component 1304 may transmit, to the network node, a report indicating that the integrity validation failed based at least in part on the second validation content not matching the first validation content.

The communication manager 1306 may identify a security issue based at least in part on a rate of detected integrity validation failures satisfying a rate threshold.

The communication manager 1306 may perform, with the network node, a security reestablishment procedure based at least in part on the integrity validation failing.

The reception component 1302 may receive, from the network node, a report indicating that the integrity validation failed.

The reception component 1302 may receive, from the network node, configuration information that indicates the time window.

The transmission component 1304 may transmit, to the network node, a request for a DCI integrity report based at least in part on identifying a likelihood metric satisfying a likelihood threshold, wherein the likelihood metric corresponds to at least one DCI transmission of the one or more DCI transmissions not originating from the network node.

The reception component 1302 may receive, from the network node, the DCI integrity report that includes integrity information for the one or more DCI transmissions.

The reception component 1302 or the transmission component 1304 may communicate, with a network node, one or more wireless messages that are encrypted using a first encryption key. The communication manager 1306 may perform an encryption seed change procedure that generates a second encryption key based at least in part on identifying a security issue associated with the one or more wireless messages. The transmission component 1304 may transmit, to the network node, a report that indicates an update from using the first encryption key to using the second encryption key.

The reception component 1302 may receive, from the network node prior to performing the encryption seed change procedure, configuration information that indicates the authentication function.

The communication manager 1306 may communicate, with the network node, a wireless message encrypted using the second encryption key based at least in part on a timer expiring, wherein the timer is initiated in accordance with transmitting the report.

The reception component 1302 may receive, from the network node, configuration information that indicates the timer.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a network node, or a network node may include the apparatus 1400. In some aspects, the apparatus 1400 includes a reception component 1402, a transmission component 1404, or a communication manager 1406, which may be in communication with one another (for example, via one or more buses or one or more other components). In some aspects, the communication manager 1406 is the communication manager 155 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 145 described in connection with FIG. 1) of the network node.

In some aspects, the apparatus 1400 may be configured to perform one or more operations described herein in connection with FIGS. 2-8. Additionally, or alternatively, the apparatus 1400 may be configured to perform one or more processes described herein, such as process 1100 of FIG. 11, process 1200 of FIG. 12, or a combination thereof. In some aspects, the apparatus 1400 or one or more components shown in FIG. 14 may include one or more components of the network node described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the network node described above in connection with FIG. 1, such as a radio, one or more RF chains, one or more transceivers, or one or more modems, each of which may in turn be coupled with one or more antennas of the network node. In some aspects, the reception component 1402 or the transmission component 1404 may include or may be included in a network interface. The network interface may be configured to obtain or output signals for the apparatus 1400 via one or more communications links, such as a backhaul link, a midhaul link, or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1404 may be co-located with the reception component 1402.

The communication manager 1406 may support operations of the reception component 1402 or the transmission component 1404. For example, the communication manager 1406 may receive information associated with configuring reception of communications by the reception component 1402 or transmission of communications by the transmission component 1404. Additionally, or alternatively, the communication manager 1406 may generate or provide control information to the reception component 1402 or the transmission component 1404 to control reception or transmission of communications.

The transmission component 1404 may transmit, to a UE, one or more DCI transmissions. The reception component 1402 or the transmission component 1404 may communicate, with the UE, a wireless message, wherein the wireless message comprises first validation content derived from a payload of the one or more DCI transmissions, and wherein the first validation content is used for an integrity validation of the one or more DCI transmissions.

The transmission component 1404 may transmit, to the UE, a report indicating that the integrity validation failed based at least in part on the second validation content not matching the first validation content.

The communication manager 1406 may identify a security issue based at least in part on a rate of detected integrity validation failures satisfying a rate threshold.

The communication manager 1406 may perform, with the UE, a security reestablishment procedure based at least in part on the integrity validation failing.

The reception component 1402 may receive, from the UE, a report indicating that the integrity validation failed.

The transmission component 1404 may transmit, to the UE, configuration information that indicates the time window.

The reception component 1402 may receive, from the UE, a request for a DCI integrity report for the one or more DCI transmissions.

The transmission component 1404 may transmit, to the UE, the DCI integrity report that includes integrity information for the one or more DCI transmissions.

The reception component 1402 or the transmission component 1404 may communicate, with a UE, one or more wireless messages that are encrypted using a first encryption key. The reception component 1402 may receive, from the UE, a report that indicates an update from using the first encryption key to using a second encryption key. The communication manager 1406 may perform an encryption seed change procedure that generates the second encryption key based at least in part on receiving the report.

The transmission component 1404 may transmit, to the UE prior to receiving the report, configuration information that indicates the authentication function.

The communication manager 1406 may communicate, with the UE, a wireless message encrypted using the second encryption key based at least in part on a timer expiring, wherein the timer is initiated in accordance with transmitting the report.

The transmission component 1404 may transmit, to the UE, configuration information that indicates the timer.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: receiving, from a network node, one or more downlink control information (DCI) transmissions; and communicating, with the network node, a wireless message, wherein the wireless message comprises first validation content derived from a payload of the one or more DCI transmissions, and wherein the first validation content is used for an integrity validation of the one or more DCI transmissions.

Aspect 2: The method of Aspect 1, wherein the wireless message is a downlink transport block received from the network node, the method further comprising: generating second validation content derived from the payload of the one or more DCI transmissions, wherein the integrity validation is based at least in part on comparing the second validation content to the first validation content.

Aspect 3: The method of Aspect 2, further comprising: transmitting, to the network node, a report indicating that the integrity validation failed based at least in part on the second validation content not matching the first validation content.

Aspect 4: The method of Aspect 3, wherein the report indicates the integrity validation failed based at least in part on indicating one or more of a binary indication, the second validation content, or a number of DCI transmissions included in the one or more DCI transmissions.

Aspect 5: The method of Aspect 3, further comprising: identifying a security issue based at least in part on a rate of detected integrity validation failures satisfying a rate threshold.

Aspect 6: The method of any of Aspects 1-5, wherein the wireless message is an uplink transport block transmitted to the network node, the method further comprising: generating the first validation content derived from the payload of the one or more DCI transmissions, wherein the first validation content is included in the uplink transport block for the network node to perform the integrity validation.

Aspect 7: The method of Aspect 6, further comprising: performing, with the network node, a security reestablishment procedure based at least in part on the integrity validation failing.

Aspect 8: The method of Aspect 6, further comprising: receiving, from the network node, a report indicating that the integrity validation failed.

Aspect 9: The method of any of Aspects 1-8, wherein the one or more DCI transmissions have one or more of a same DCI format or a same DCI size, and wherein separate integrity validation procedures are applied independently for different DCI formats or different DCI sizes.

Aspect 10: The method of any of Aspects 1-9, wherein the one or more DCI transmissions have one or more different DCI formats or different DCI sizes, and wherein one integrity validation procedure is applied for the one or more DCI transmissions.

Aspect 11: The method of any of Aspects 1-10, wherein the one or more DCI transmissions are within a time window, and wherein a start time of the time window and an end time of the time window are both defined relative to a start time of the wireless message.

Aspect 12: The method of Aspect 11, further comprising: receiving, from the network node, configuration information that indicates the time window.

Aspect 13: The method of any of Aspects 1-12, wherein the wireless message includes the first validation content based at least in part on one or more of: a component carrier of the wireless message, a hybrid automatic repeat request identifier of the wireless message, or an indication included in a DCI that schedules or activates the wireless message.

Aspect 14: The method of any of Aspects 1-13, wherein the first validation content is derived from: one or more DCI payloads respectively from the one or more DCI transmissions before a cyclic redundancy check (CRC) attachment, one or more DCI fields respectively from the one or more DCI transmissions, one or more CRCs respectively from the one or more DCI transmissions, or a hashing function that uses the payload of the one or more DCI transmissions as an input and outputs a fixed number of bits that comprises the first validation content.

Aspect 15: The method of any of Aspects 1-14, wherein hybrid automatic repeat request retransmissions are disabled for the wireless message.

Aspect 16: The method of any of Aspects 1-15, wherein the wireless message is a configured grant physical uplink shared channel or a semi-persistent scheduling physical downlink shared channel, and wherein the one or more DCI transmissions that the first validation content is derived from is based at least in part on a time occasion of the wireless message.

Aspect 17: The method of any of Aspects 1-16, wherein the wireless message indicates a time window, and wherein the one or more DCI transmissions are used to derive the first validation content based at least in part on being within the time window.

Aspect 18: The method of any of Aspects 1-17, wherein a number of DCI transmissions included in the one or more DCI transmissions is included in the first validation content included in the wireless message.

Aspect 19: The method of any of Aspects 1-18, further comprising: transmitting, to the network node, a request for a DCI integrity report based at least in part on identifying a likelihood metric satisfying a likelihood threshold, wherein the likelihood metric corresponds to at least one DCI transmission of the one or more DCI transmissions not originating from the network node, and receiving, from the network node, the DCI integrity report that includes integrity information for the one or more DCI transmissions.

Aspect 20: A method of wireless communication performed by a user equipment (UE), comprising: communicating, with a network node, one or more wireless messages that are encrypted using a first encryption key; performing an encryption seed change procedure that generates a second encryption key based at least in part on identifying a security issue associated with the one or more wireless messages; and transmitting, to the network node, a report that indicates an update from using the first encryption key to using the second encryption key.

Aspect 21: The method of Aspect 20, wherein the encryption seed change procedure includes an authentication function for generating one or more encryption keys.

Aspect 22: The method of Aspect 21, further comprising: receiving, from the network node prior to performing the encryption seed change procedure, configuration information that indicates the authentication function.

Aspect 23: The method of any of Aspects 20-22, further comprising: communicating, with the network node, a wireless message encrypted using the second encryption key based at least in part on a timer expiring, wherein the timer is initiated in accordance with transmitting the report.

Aspect 24: The method of Aspect 23, further comprising: receiving, from the network node, configuration information that indicates the timer.

Aspect 25: A method of wireless communication performed by a network node, comprising: transmitting, to a user equipment (UE), one or more downlink control information (DCI) transmissions; and communicating, with the UE, a wireless message, wherein the wireless message comprises first validation content derived from a payload of the one or more DCI transmissions, and wherein the first validation content is used for an integrity validation of the one or more DCI transmissions.

Aspect 26: The method of Aspect 25, wherein the wireless message is an uplink transport block received from the UE, the method further comprising: generating second validation content derived from the payload of the one or more DCI transmissions, wherein the integrity validation is based at least in part on comparing the second validation content to the first validation content.

Aspect 27: The method of Aspect 26, further comprising: transmitting, to the UE, a report indicating that the integrity validation failed based at least in part on the second validation content not matching the first validation content.

Aspect 28: The method of Aspect 27, wherein the report indicates the integrity validation failed based at least in part on indicating one or more of a binary indication, the second validation content, or a number of DCI transmissions included in the one or more DCI transmissions.

Aspect 29: The method of Aspect 27, further comprising: identifying a security issue based at least in part on a rate of detected integrity validation failures satisfying a rate threshold.

Aspect 30: The method of any of Aspects 25-29, wherein the wireless message is a downlink transport block transmitted to the network node, the method further comprising: generating the first validation content derived from the payload of the one or more DCI transmissions, wherein the first validation content is included in the downlink transport block for the UE to perform the integrity validation.

Aspect 31: The method of Aspect 30, further comprising: performing, with the UE, a security reestablishment procedure based at least in part on the integrity validation failing.

Aspect 32: The method of Aspect 30, further comprising: receiving, from the UE, a report indicating that the integrity validation failed.

Aspect 33: The method of any of Aspects 25-32, wherein the one or more DCI transmissions have one or more of a same DCI format or a same DCI size, and wherein separate integrity validation procedures are applied independently for different DCI formats or different DCI sizes.

Aspect 34: The method of any of Aspects 25-33, wherein the one or more DCI transmissions have one or more different DCI formats or different DCI sizes, and wherein one integrity validation procedure is applied for the one or more DCI transmissions.

Aspect 35: The method of any of Aspects 25-34, wherein the one or more DCI transmissions are within a time window, and wherein a start time of the time window and an end time of the time window are both defined relative to a start time of the wireless message.

Aspect 36: The method of Aspect 35, further comprising: transmitting, to the UE, configuration information that indicates the time window.

Aspect 37: The method of any of Aspects 25-36, wherein the wireless message includes the first validation content based at least in part on one or more of: a component carrier of the wireless message, a hybrid automatic repeat request identifier of the wireless message, or an indication included in a DCI that schedules or activates the wireless message.

Aspect 38: The method of any of Aspects 25-37, wherein the first validation content is derived from: one or more DCI payloads respectively from the one or more DCI transmissions before a cyclic redundancy check (CRC) attachment, one or more DCI fields respectively from the one or more DCI transmissions, one or more CRCs respectively from the one or more DCI transmissions, or a hashing function that uses the payload of the one or more DCI transmissions as an input and outputs a fixed number of bits that comprises the first validation content.

Aspect 39: The method of any of Aspects 25-38, wherein hybrid automatic repeat request retransmissions are disabled for the wireless message.

Aspect 40: The method of any of Aspects 25-39, wherein the wireless message is a configured grant physical uplink shared channel or a semi-persistent scheduling physical downlink shared channel, and wherein the one or more DCI transmissions that the first validation content is derived from is based at least in part on a time occasion of the wireless message.

Aspect 41: The method of any of Aspects 25-40, wherein the wireless message indicates a time window, and wherein the one or more DCI transmissions are used to derive the first validation content based at least in part on being within the time window.

Aspect 42: The method of any of Aspects 25-41, wherein a number of DCI transmissions included in the one or more DCI transmissions is included in the first validation content included in the wireless message.

Aspect 43: The method of any of Aspects 25-42, further comprising: receiving, from the UE, a request for a DCI integrity report for the one or more DCI transmissions; and transmitting, to the UE, the DCI integrity report that includes integrity information for the one or more DCI transmissions.

Aspect 44: A method of wireless communication performed by a network node, comprising: communicating, with a user equipment (UE), one or more wireless messages that are encrypted using a first encryption key; receiving, from the UE, a report that indicates an update from using the first encryption key to using a second encryption key; and performing an encryption seed change procedure that generates the second encryption key based at least in part on receiving the report.

Aspect 45: The method of Aspect 44, wherein the encryption seed change procedure includes an authentication function for generating one or more encryption keys.

Aspect 46: The method of Aspect 45, further comprising: transmitting, to the UE prior to receiving the report, configuration information that indicates the authentication function.

Aspect 47: The method of any of Aspects 44-46, further comprising: communicating, with the UE, a wireless message encrypted using the second encryption key based at least in part on a timer expiring, wherein the timer is initiated in accordance with transmitting the report.

Aspect 48: The method of Aspect 47, further comprising: transmitting, to the UE, configuration information that indicates the timer.

Aspect 49: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-48.

Aspect 50: An apparatus for wireless communication at a device, the apparatus comprising one or more memories and one or more processors coupled to the one or more memories, the one or more processors configured to cause the device to perform the method of one or more of Aspects 1-48.

Aspect 51: An apparatus for wireless communication, the apparatus comprising at least one means for performing the method of one or more of Aspects 1-48.

Aspect 52: A non-transitory computer-readable medium storing code for wireless communication, the code comprising instructions executable by one or more processors to perform the method of one or more of Aspects 1-48.

Aspect 53: A non-transitory computer-readable medium storing a set of instructions for wireless communication, the set of instructions comprising one or more instructions that, when executed by one or more processors of a device, cause the device to perform the method of one or more of Aspects 1-48.

Aspect 54: A device for wireless communication, the device comprising a processing system that includes one or more processors and one or more memories coupled with the one or more processors, the processing system configured to cause the device to perform the method of one or more of Aspects 1-48.

Aspect 55: An apparatus for wireless communication at a device, the apparatus comprising one or more memories and one or more processors coupled to the one or more memories, the one or more processors individually or collectively configured to cause the device to perform the method of one or more of Aspects 1-48.

Aspect 56: A device comprising a processing system that includes one or more processors and one or more code-storing memories coupled with the one or more processors, the processing system configured to cause the device to perform the method of one or more of Aspects 1-48.

Aspect 57: A device comprising a processing system that includes processor circuitry and code-storing memory circuitry, the processing system configured to cause the device to perform the method of one or more of Aspects 1-48.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, from a network node, one or more control information transmissions; and
communicate, with the network node, a wireless message, wherein the wireless message comprises first validation content derived from a payload of the one or more control information transmissions, and wherein the first validation content is used for an integrity validation of the one or more control information transmissions.

2. The UE of claim 1, wherein the wireless message is a downlink transport block received from the network node, the one or more processors are further configured to cause the UE to:
generate second validation content derived from the payload of the one or more control information transmissions, wherein the integrity validation is based at least in part on comparing the second validation content to the first validation content.

3. The UE of claim 2, wherein the one or more processors are further configured to cause the UE to:
transmit, to the network node, a report indicating that the integrity validation failed based at least in part on the second validation content not matching the first validation content.

4. The UE of claim 3, wherein the report indicates the integrity validation failed based at least in part on indicating one or more of a binary indication, the second validation content, or a number of control information transmissions included in the one or more control information transmissions.

5. The UE of claim 3, wherein the one or more processors are further configured to cause the UE to:
identify a security issue based at least in part on a rate of detected integrity validation failures satisfying a rate threshold.

6. The UE of claim 1, wherein the wireless message is an uplink transport block transmitted to the network node, the one or more processors are further configured to cause the UE to:
generate the first validation content derived from the payload of the one or more control information transmissions, wherein the first validation content is included in the uplink transport block for the network node to perform the integrity validation.

7. The UE of claim 6, wherein the one or more processors are further configured to cause the UE to:
perform, with the network node, a security reestablishment procedure based at least in part on the integrity validation failing.

8. The UE of claim 6, wherein the one or more processors are further configured to cause the UE to:
receive, from the network node, a report indicating that the integrity validation failed.

9. The UE of claim 1, wherein the one or more control information transmissions have one or more of a same downlink control information (DCI) format or a same DCI size, and wherein separate integrity validation procedures are applied independently for different DCI formats or different DCI sizes.

10. The UE of claim 1, wherein the one or more control information transmissions have one or more different downlink control information (DCI) formats or different DCI sizes, and wherein one integrity validation procedure is applied for the one or more control information transmissions.

11. The UE of claim 1, wherein the one or more control information transmissions are within a time window, and wherein a start time of the time window and an end time of the time window are both defined relative to a start time of the wireless message.

12. The UE of claim 11, wherein the one or more processors are further configured to cause the UE to:
receive, from the network node, configuration information that indicates the time window.

13. The UE of claim 1, wherein the wireless message includes the first validation content based at least in part on one or more of:
a component carrier of the wireless message,
a hybrid automatic repeat request identifier of the wireless message, or
an indication included in a downlink control information (DCI) that schedules or activates the wireless message.

14. The UE of claim 1, wherein the first validation content is derived from:
one or more downlink control information (DCI) payloads respectively from the one or more control information transmissions before a cyclic redundancy check (CRC) attachment,
one or more DCI fields respectively from the one or more control information transmissions,
one or more CRCs respectively from the one or more control information transmissions, or
a hashing function that uses the payload of the one or more control information transmissions as an input and outputs a fixed number of bits that comprises the first validation content.

15. The UE of claim 1, wherein hybrid automatic repeat request retransmissions are disabled for the wireless message.

16. The UE of claim 1, wherein the wireless message is a configured grant physical uplink shared channel or a semi-persistent scheduling physical downlink shared channel, and wherein the one or more control information transmissions that the first validation content is derived from is based at least in part on a time occasion of the wireless message.

17. The UE of claim 1, wherein the wireless message indicates a time window, and wherein the one or more control information transmissions are used to derive the first validation content based at least in part on being within the time window.

18. The UE of claim 1, wherein a number of control information transmissions included in the one or more control information transmissions is included in the first validation content included in the wireless message.

19. A user equipment (UE) for wireless communication, comprising:
one or more memories; and
one or more processors, coupled to the one or more memories, configured to cause the UE to:
communicate, with a network node, one or more wireless messages that are encrypted using a first encryption key;
perform an encryption seed change procedure that generates a second encryption key based at least in part on identifying a security issue associated with the one or more wireless messages; and
transmit, to the network node, a report that indicates an update from using the first encryption key to using the second encryption key.

20. A method of wireless communication performed by a user equipment (UE), comprising:
receiving, from a network node, one or more control information transmissions; and
communicating, with the network node, a wireless message, wherein the wireless message comprises first validation content derived from a payload of the one or more control information transmissions, and wherein the first validation content is used for an integrity validation of the one or more control information transmissions.
